(19) United States
(12) Patent Application Publication
(10) Pub. No.: US 2026/0095556 A1
(43) Pub. Date: Apr. 2, 2026

(54) CORRECTION VALUE CALCULATION METHOD, NON-TRANSITORY COMPUTER-READABLE STORAGE MEDIUM STORING PROGRAM, AND PROJECTION APPARATUS

(71) Applicant: SEIKO EPSON CORPORATION, Tokyo (JP)

(72) Inventors: Shiki FURUI, Matsumoto-shi (JP); Momoko IMAI, Matsumoto-shi (JP)

(73) Assignee: SEIKO EPSON CORPORATION, Tokyo (JP)

(21) Appl. No.: 19/341,353

(22) Filed: Sep. 26, 2025

(30) Foreign Application Priority Data
Sep. 27, 2024 (JP) 2024-168992

(51) Int. Cl. H04N 9/31

(52) U.S. Cl. CPC H04N 9/3182; H04N 9/3147

(57) ABSTRACT

A correction value calculation method including calculating a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface and calculating, based on the first color unevenness correction value, for the second portion, a brightness correction value for performing brightness correction for reducing a difference in brightness of black between the first portion and the second portion on the projection surface.

The present application is based on, and claims priority from JP Application Serial Number 2024-168992, filed Sep. 27, 2024 the disclosure of which is hereby incorporated by reference herein in its entirety.

### BACKGROUND

### 1. Technical Field

The present disclosure relates to a correction value calculation method, a non-transitory computer-readable storage medium storing a program, and a projection apparatus.

### 2. Related Art

JP-A-2014-81412 discloses a black level region setting method for, when a plurality of projection apparatuses project projection images such that the projection images partially overlap, setting black level regions, which are adjustment target regions of a black level, on the projection images. In the black level region setting method, a plurality of position-adjustable guides are arranged on the projection images and the black level regions are set based on the arrangement of the guides. Further, in the black level region setting method, the brightness and the chromaticity of black are adjusted in the black level regions.

JP-A-2014-81412 is an example of the related art.

In the black level region setting method according to JP-A-2014-81412, since the brightness and the chromaticity of black are adjusted for each of the black level regions set based on the arrangement of the guides, for example, when there is color unevenness of black in the entire projection images, the color unevenness cannot be corrected.

### SUMMARY

According to an aspect of the present disclosure, there is provided a correction value calculation method including: calculating, based on a target tone value, a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface; and calculating, based on the first color unevenness correction value, for the second portion, a brightness correction value for performing brightness correction for reducing a difference in brightness of black between the first portion and the second portion on the projection surface.

According to an aspect of the present disclosure, there is provided a non-transitory computer-readable storage medium storing a program, the program causing a computer to execute: calculating, based on a target tone value, a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface; and calculating, based on the first color unevenness correction value, for the second portion, a brightness correction value for performing brightness correction for reducing a difference in brightness of black between the first portion and the second portion on the projection surface.

According to an aspect of the present disclosure, there is provided a projection apparatus including at least one image processing circuit configured to execute: calculating, based on a target tone value, a first color unevenness correction value for correcting color unevenness of a first image for each of a plurality of first correction points included in a first portion of the first image, the first image including the first portion projected onto a projection surface and overlapping, on the projection surface, a second image projected by another projection apparatus onto the projection surface and a second portion projected onto the projection surface and not overlapping the second image on the projection surface; and calculating, based on the first color unevenness correction value, for the second portion, a brightness correction value for performing brightness correction for reducing a difference in brightness of black between the first portion and the second portion on the projection surface.

### BRIEF DESCRIPTION OF THE DRAWINGS

FIG. 1 is a diagram illustrating an overall configuration of a projection system.

FIG. 2 is a block diagram of a projection apparatus.

FIG. 3 is a functional block diagram of a corrector.

FIG. 4 is a flowchart illustrating an operation example of the projection apparatus according to a first embodiment.

FIG. 5 is a diagram illustrating an example of grid points.

FIG. 6 is a diagram illustrating an example of the grid points.

FIG. 7 is a diagram illustrating an example of the grid points.

FIG. 8 is a flowchart illustrating sub-steps SS4[1] to SS4[5] configuring step S4.

FIG. 9 is a diagram illustrating an example of a correction region of a brightness correction circuit.

FIG. 10 is a diagram illustrating a processing procedure of the brightness correction circuit and a color unevenness correction circuit.

FIG. 11 is a diagram illustrating an example of a calculation status of a color unevenness correction value S₀, a brightness correction value C₀, an ideal output value Aᵢ, and a color unevenness correction value S₁ in sub-step SS4[1].

FIG. 12 is a diagram illustrating an example of a calculation status of the color unevenness correction value S₀, the brightness correction value C₀, the ideal output value Aᵢ, and the color unevenness correction value S₁ in sub-step SS4[2].

FIG. 13 is a diagram illustrating an example of a calculation status of the color unevenness correction value S₀, the brightness correction value C₀, the ideal output value Aᵢ, and the color unevenness correction value S₁ in sub-step SS4[2].

FIG. 14 is a diagram of processing content in sub-step SS4[3].

FIG. 15 is a diagram illustrating an example of a calculation status of the color unevenness correction value S₀, the brightness correction value C₀, the ideal output value Aᵢ, and the color unevenness correction value S₁ in sub-step SS4[3].

FIG. 16 is a diagram illustrating an example of a calculation status of the color unevenness correction value S₀, the brightness correction value C₀, the ideal output value Aᵢ, and the color unevenness correction value S₁ in sub-step SS4[4].

FIG. 17 is a diagram illustrating an example of a calculation status of the color unevenness correction value S₀, the brightness correction value C₀, the ideal output value Aᵢ, and the color unevenness correction value S₁ in sub-step SS4[5].

FIG. 18 is a flowchart illustrating sub-steps SS4[1]_1 to SS4[1]_7 configuring sub-step SS4[1].

FIG. 19 is a diagram illustrating an example of a target tone value (r, g, b) at grid points.

FIG. 20 is a diagram illustrating an example of the target tone value (r, g, b) at the grid points and a tone value at grid points adjacent to a boundary between a overlapped region and a non-overlapped region.

FIG. 21 is a diagram illustrating an example of a method of determining the tone value serving as a target value of the grid point for which a target tone value is not determined.

FIG. 22 is a diagram illustrating an example of a method of determining the tone value serving as the target value of the grid point for which the target tone value is not determined.

FIG. 23 is a diagram illustrating an example of a calculation status of the target tone value.

FIG. 24 is a diagram illustrating an example of a calculation status of the target tone value.

FIG. 25 is a diagram illustrating an example of a calculation status of the target tone value.

FIG. 26 is a diagram illustrating an example of smoothing.

FIG. 27 is a diagram illustrating an example of smoothing.

FIG. 28 is a diagram illustrating an example of a status of smoothing of the target tone value.

FIG. 29 is a diagram illustrating an example of a status of the smoothing of the target tone value.

FIG. 30 is a diagram illustrating an example of a status of the smoothing of the target tone value.

FIG. 31 is a diagram illustrating three-dimensional display of target values of grid points before smoothing.

FIG. 32 is a diagram illustrating three-dimensional display of target values of the grid points after the smoothing is completed.

FIG. 33 is a diagram of a projection image PI_A in the case in which projection apparatuses are disposed in two rows and two columns.

FIG. 34 is a diagram illustrating the grid points included in each of a non-overlapped region, a double overlapped region, and a quadruple overlapped region in a projection image.

### DESCRIPTION OF EMBODIMENTS

Embodiments of the present disclosure are explained below with reference to the drawings. However, in the figures, dimensions and scales of units are differentiated from actual ones as appropriate. Since the embodiments explained below are suitable specific examples of the present disclosure, technically preferable various restrictions are applied to the embodiments. However, the scope of the present disclosure is not limited to the embodiments unless there is particularly a description to the effect that the present disclosure is limited in the following explanation.

### 1: First Embodiment

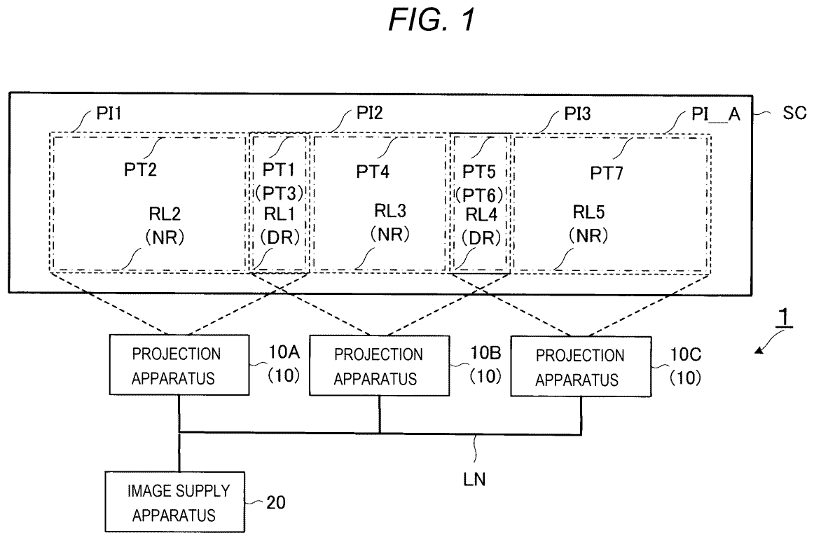

Hereinafter, a projection system 1 according to a first embodiment is explained with reference to FIGS. 1 to 32.

### 1-1: Configuration of the First Embodiment

### 1-1-1: Overall Configuration

FIG. 1 is a diagram illustrating an overall configuration of the projection system 1. The projection system 1 includes a projection apparatus 10A, a projection apparatus 10B, a projection apparatus 10C, and an image supply apparatus 20. The projection apparatus 10A is an example of a “first projection apparatus”. The projection apparatus 10B is an example of a “second projection apparatus”.

The projection apparatus 10A, the projection apparatus 10B, the projection apparatus 10C, and the image supply apparatus 20 are communicably connected to one another via a communication line LN.

The projection apparatus 10A, the projection apparatus 10B, and the projection apparatus 10C project various images or videos onto a projection surface SC. As an example, among the projection apparatus 10A, the projection apparatus 10B, and the projection apparatus 10C, the projection apparatus 10A is a primary projection apparatus for the projection apparatus 10B and the projection apparatus 10C. The projection apparatus 10B and the projection apparatus 10C are secondary projection apparatuses for the projection apparatus 10A. Specifically, the projection apparatus 10A transmits various control signals to each of the projection apparatus 10B and the projection apparatus 10C. As a result, the projection apparatus 10A controls the projection apparatus 10B and the projection apparatus 10C. The control signals include various correction values explained below.

The image supply apparatus 20 supplies various images to the projection apparatus 10A, the projection apparatus 10B, and the projection apparatus 10C. Each of the projection apparatus 10A, the projection apparatus 10B, and the projection apparatus 10C projects an image supplied from the image supply apparatus 20 onto the projection surface SC.

Alternatively, the image supply apparatus 20 may supply an image only to the projection apparatus 10A, and the projection apparatus 10A may supply images to be projected by the projection apparatuses 10 to each of the projection apparatus 10B and the projection apparatus 10C. In the present embodiment, when the projection apparatus 10A to the projection apparatus 10C are not distinguished, the projection apparatus 10A to the projection apparatus 10C are referred to as the projection apparatuses 10.

Alternatively, in the projection system 1, the projection apparatus 10A, the projection apparatus 10B, and the projection apparatus 10C may read, from the storage devices 14 provided therein, images to be projected and project the images onto the projection surface SC. Alternatively, the projection apparatus 10A may read, from the storage device 14 provided therein, an image to be projected and supply images to be projected by the projection apparatuses 10 to each of the projection apparatus 10B and the projection apparatus 10C. In this case, the projection system 1 may not always include the image supply apparatus 20.

In the example illustrated in FIG. 1, the projection apparatus 10A projects a projection image PI1 onto the projection surface SC. The projection image PI1 is an example of a “first image”. The projection apparatus 10B projects a projection image PI2 onto the projection surface SC. The projection image PI2 is an example of a “second image”. The projection apparatus 10C projects a projection image PI3 onto the projection surface SC. The projection image PI1, the projection image PI2, and the projection image PI3 are projected onto the projection surface SC to be partially overlapped on one another, whereby one projection image PI_A is displayed as a whole on the projection surface SC.

Specifically, the projection image PI1 includes a portion PT1 and a portion PT2. The projection image PI2 includes a portion PT3, a portion PT4, and a portion PT5. The projection image PI3 includes a portion PT6 and a portion PT7.

The portion PT1 of the projection image PI1 and the portion PT3 of the projection image PI2 are projected onto the projection surface SC to be overlapped. The portion PT5 of the projection image PI2 and the portion PT6 of the projection image PI3 are projected onto the projection surface SC to be overlapped.

The portion PT1 is an example of a “first portion”. The portion PT2 is an example of a “second portion”.

As a result, the portion PT1 of the projection image PI1 and the portion PT3 of the projection image PI2 are projected onto a region RL1 of the projection surface SC. Only the portion PT2 of the projection image PI1 is projected onto a region RL2 of the projection surface SC. Only the portion PT4 of the projection image PI2 is projected onto a region RL3 of the projection surface SC. The portion PT5 of the projection image PI2 and the portion PT6 of the projection image PI3 are projected onto a region RL4 of the projection surface SC. The portion PT7 of the projection image PI3 is projected onto a region RL5 of the projection surface SC.

Among a plurality of regions RL of the projection surface SC, the region RL1 and the region RL4 are overlapped regions DR. On the other hand, the region RL2, the region RL3, and the region RL5 are non-overlapped regions NR.

### 1-1-2: Configuration of the Projection Apparatus

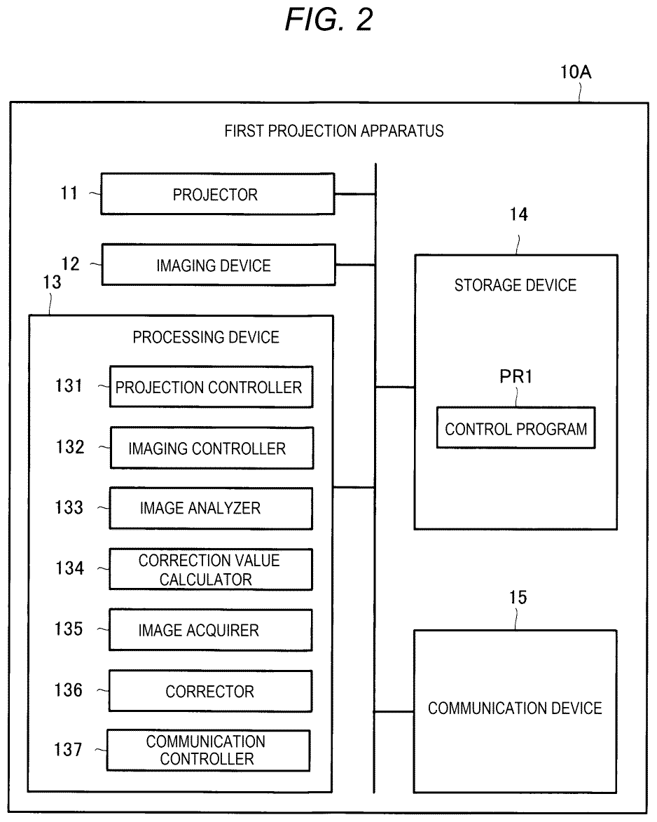

FIG. 2 is a block diagram of the projection apparatus 10A. The projection apparatus 10B and the projection apparatus 10C may have the same configuration as the configuration of the projection apparatus 10A. Alternatively, the projection apparatus 10B and the projection apparatus 10C may have a configuration essential as a projection apparatus and, on the other hand, may have a configuration not including at least one of an imaging device 12, an imaging controller 132, an image analyzer 133, a correction value calculator 134, an image acquirer 135, and a corrector 136 explained below.

The projection apparatus 10A includes a projector 11, the imaging device 12, a processing device 13, a storage device 14, and a communication device 15.

The elements of the projection apparatus 10A are connected to one another via a single bus or a plurality of buses for communicating information. The elements of the projection apparatus 10A may include one or a plurality of pieces of equipment and some elements of the projection apparatus 10A may be omitted.

The projector 11 is a device that projects various projection images PI onto the projection surface SC such as a screen or a wall. The projector 11 projects the various projection images PI under the control by the processing device 13. The projector 11 includes, for example, a light source, a projection lens, a dichroic mirror, a prism, and a liquid crystal panel, modulates light from the light source using the liquid crystal panel, and projects the modulated light onto the projection surface SC via the projection lens. The light source, the projection lens, the dichroic mirror, and the prism are examples of a projection optical system.

The imaging device 12 is a device that captures the projection image PI projected onto the projection surface SC. The imaging device 12 captures various images under the control by the processing device 13. The imaging device 12 is, for example, an image sensor. The imaging device 12 is an example of a “sensor”.

The processing device 13 is a processor that controls the entire projection apparatus 10A and includes, for example, one or a plurality of chips. The processing device 13 includes, for example, a central processing unit (CPU) including an interface with peripheral devices, an arithmetic operation device, and a register. Some or all of the functions of the processing device 13 may be implemented by hardware such as a digital signal processor (DSP), an application specific integrated circuit (ASIC), a programmable logic device (PLD), or a field programmable gate array (FPGA). The processing device 13 may include a system on chip (SoC). The processing device 13 executes various kinds of processing in parallel or in sequence. The processing device 13 or the projection apparatus 10A is an example of a “computer”. The processing device 13 is an example of an “image processing circuit”.

The storage device 14 is a recording medium readable by the processing device 13 and stores a plurality of programs including a control program PR1 to be executed by the processing device 13. The storage device 14 stores a pattern image for measurement projected from the projector 11 at the time of correction explained below. Hereinafter, the pattern image for measurement is sometimes referred to as measurement pattern. The storage device 14 may include, for example, at least one of a read only memory (ROM), an erasable programmable ROM (EPROM), an electrically erasable programmable ROM (EEPROM), and a random access memory (RAM). The storage device 14 may be called register, cache, main memory, main storage device, or the like.

The communication device 15 is hardware serving as a transmission and reception device for performing communication with other devices. The communication device 15 is also called, for example, network device, network controller, network card, or communication module. The communication device 15 may include a connector for wired connection and an interface circuit corresponding to the connector. The communication device 15 may include a wireless communication interface. Examples of the connector for wired connection and the interface circuit include those conforming to a wired LAN (Local region Network), IEEE 1394, and a USB (Universal Serial Bus). Examples of the wireless communication interface include those conforming to a wireless LAN and Bluetooth (registered trademark).

The processing device 13 reads and executes the control program PR1 from the storage device 14 to thereby function as a projection controller 131, the imaging controller 132, the image analyzer 133, the correction value calculator 134, the image acquirer 135, the corrector 136, and a communication controller 137. Note that the control program PR1 may be transmitted from, via a communication network, another device such as a server that manages the projection apparatus 10A.

The projection controller 131 causes the projector 11 to project the measurement pattern explained above onto the projection surface SC. The projection controller 131 causes the projector 11 to project an image acquired from the image supply apparatus 20 by the image acquirer 135 explained below onto the projection surface SC.

The imaging controller 132 causes the imaging device 12 to image reflected light of the measurement pattern projected onto the projection surface SC.

The image analyzer 133 analyzes the reflected light of the measurement pattern imaged by the imaging device 12 and calculates a measurement value indicating a color of the measurement pattern in a captured image.

The correction value calculator 134 calculates, based on the measurement value calculated by the image analyzer 133, a correction value to be set in the corrector 136 explained below. A specific example of a calculation method for the correction value by the correction value calculator 134 is explained below in explanation of an operation of the present embodiment with reference to FIGS. 4 to 32.

Hereinafter, a measurement pattern for correction of black projected by the projection controller 131 in the present embodiment is explained.

As an example, a projection apparatus having a normal color adjustment function generally equally divides colors from the lowest tone on a black side to the highest tone on a white side, projects color light having colors of tones at division points, and calculates a correction value based on an imaging result obtained by imaging the color light projected on a projection surface. At this time, the projection apparatus estimates a color of an intermediate tone between a tone of first color light and a tone of second color light based on interpolation operation such as spline interpolation and calculates a correction value based on a result of the estimation.

Alternatively, as another example, the projection apparatus having the normal color adjustment function projects color light having a color based on gray of an intermediate tone and calculates a correction value based on an imaging result obtained by imaging the color light projected onto the projection surface. In this case, colors other than gray are estimated based on the interpolation operation using the property of additive color mixture and a correction value is calculated based on a result of the estimation.

However, since a color of color light on a low tone side close to black with a tone of 0 is color light obtained by adding light gradually subjected to RGB modulation to color light having black color with the tone of 0 on an entire surface, there is a problem in that a change in chromaticity is large and an estimation error is large in the measurement method of the related art. Thus, in the present embodiment, color light having colors of tones obtained by dividing a tone 0 to a predetermined tone more finely than tones equal to or higher than the predetermined tone is projected as a measurement pattern. Accordingly, it is possible to further reduce an estimation error in a low tone range close to black than when measurement is performed with the same fineness regardless of a tone. For example, a range up to a tone 146 of a first division obtained by dividing a tone width from the tone 0 to a tone 1023 into seven may be equally divided. The fineness of the division may be two or more divisions. It is more suitable to use a measurement pattern of gray included between the tone 0 and the predetermined tone and a plurality of measurement patterns obtained by respectively changing one color component among color components of an R component, a G component, and a

B component based on the measurement pattern of gray. Compared with when the range of the low tone is equally divided, the accuracy of estimating a change in chromaticity at the low tone explained above is improved.

In the above explanation, as an example, the liquid crystal panel provided in the projector 11 includes three panels of a panel corresponding to the R component, a panel corresponding to the G component, and a panel corresponding to the B component. However, the same effects are achieved when the liquid crystal panel includes only one panel.

Referring back to FIG. 2, the image acquirer 135 acquires, from the image supply apparatus 20, an image to be projected.

The corrector 136 corrects the image acquired by the image acquirer 135 using the correction value calculated by the correction value calculator 134.

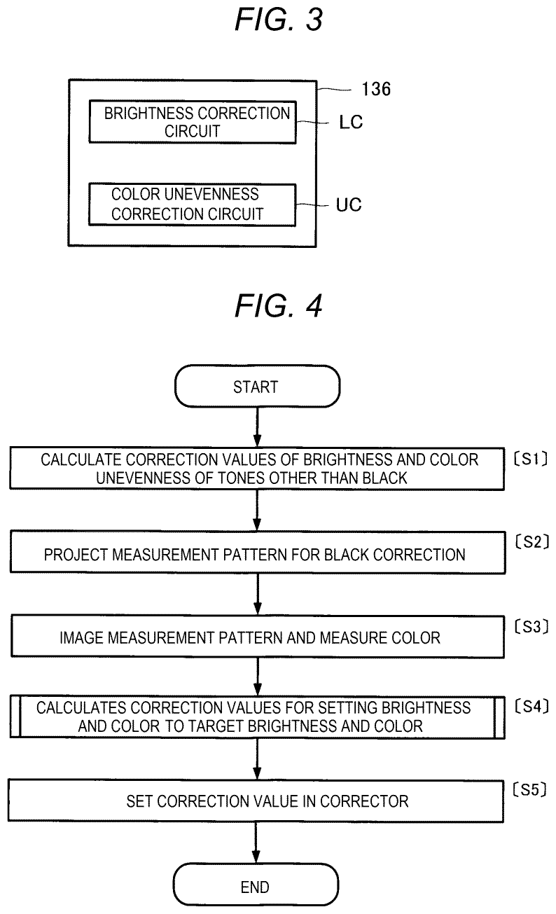

FIG. 3 is a functional block diagram of the corrector 136. The corrector 136 includes a brightness correction circuit LC and a color unevenness correction circuit UC.

The brightness correction circuit LC corrects the brightness of the image acquired by the image acquirer 135 using the correction value calculated by the correction value calculator 134. The correction includes correction of so-called “black floating”. The “black floating” means a difference in brightness between a overlapped region DR and a non-overlapped region NR on the projection surface SC at the time when the projection apparatus 10 projects the projection image PI onto the projection surface SC to display a black image with the tone 0 on the projection surface SC. Therefore, the correcting the “black floating” is brightness correction that reduces the difference in brightness between the overlapped region DR and the non-overlapped region NR.

The color unevenness correction circuit UC corrects color unevenness of the image acquired by the image acquirer 135 using the correction value calculated by the correction value calculator 134. Details of the brightness correction circuit LC and the color unevenness correction circuit UC are explained below.

In FIG. 2, the projection controller 131 causes the projector 11 to project the image corrected by the corrector 136 onto the projection surface SC as the projection image PI.

The communication controller 137 causes the communication device 15 to transmit and receive various information to and from an external device. The various information include the correction value transmitted from the projection apparatus 10A to each of the projection apparatus 10B and the projection apparatus 10C.

### 1-2: Operation in the First Embodiment

FIG. 4 is a flowchart illustrating an operation example of the projection apparatus 10A according to the first embodiment.

In step S1, the projection apparatus 10A calculates a correction value of brightness and a correction value of color unevenness of tones other than black. Further, the projection apparatus 10A adjusts, using the correction value, brightness and a color of the projection image PI from the projection apparatuses 10A to 10C to be uniform among the projection apparatuses 10.

“Black” here is, for example, a color included in a first tone width including the tone 0 when a tone width from the tone 0 which is the minimum tone value to the tone 1023 which is the maximum tone value, is divided into N. Here, N is an integer of three or more. Hereinafter, for convenience of explanation, N is sometimes equal to 7. In the case of N=7, “black” is a color included in tones from the tone 0 to the tone 146.

The correction of the brightness explained above is correction for reducing, for the tones other than black, the difference between the brightness of the overlapped region DR and the brightness of the non-overlapped region NR. A method used for the correction of the brightness and the color unevenness explained above may be the method of the related art. As an example, the method may be a method of correcting brightness and color unevenness by, when any region RL among the region RL1 to the region RL5 is set as a target region in FIG. 1, comparing an imaging value indicated by an imaging value obtained by imaging a target region and an imaging value obtained by imaging another region RL.

At this time, it is assumed that adjustment points in the case in which the processing device 13 corrects color unevenness of the projection image PI are, as an example, grid points LP of 11 rows×21 columns in the projection image PI. The number of tones is based on tones at boundaries obtained by equally dividing a tone width from the tone 0 to the tone 1023 into seven.

In processing in step S1, the processing device 13 determines whether each of the grid points LP used as the color unevenness correction circuit UC is included in the overlapped region DR or included in the non-overlapped region NR. For example, before step S1, the processing device 13 projects an entirely white image only from the projector 11 as a projection image and captures the entirely white image with the imaging device 12 of the projection apparatus 10A. Subsequently, the processing device 13 projects an entirely white image only from the projection apparatus 10B as a projection image and captures the entirely white image with the imaging device 12 of the projection apparatus 10A. The processing device 13 detects, from results of these kinds of imaging, the position of the right side of the entirely white image projected from the projection apparatus 10A and the position of the left side of the entirely white image projected from the projection apparatus 10B and determines a region from the position of the right side to the position of the left side as the overlapped region DR in a coordinate system of a captured image. Then, based on a correspondence relationship among a coordinate system of the projection apparatus 10A, a coordinate system of the projection apparatus 10B, and a coordinate system of the captured image generated before step S1, the processing device 13 converts the overlapped region DR in the coordinate system of the captured image into the overlapped region DR in the coordinate system of the projection apparatus 10A and the coordinate system of the projection apparatus 10B. The processing device 13 determines, based on the captured image of the grid point LP, whether each of the grid points LP is a point belonging to the overlapped region DR in the coordinate system of the projection apparatus 10A and the coordinate system of the projection apparatus 10B. The correspondence relationship can be calculated by, for example, a well-known calibration technique using a gray code. The coordinate system of the projection apparatus 10A is a two-dimensional coordinate system of a liquid crystal panel. The same applies to the coordinate system of the projection apparatus 10B. The same applies to the projection apparatus 10B and the projection apparatus 10C.

The process explained above is merely an example and a method of determining whether each of the grid points LP is included in the overlapped region DR or included in the non-overlapped region NR can be changed as appropriate.

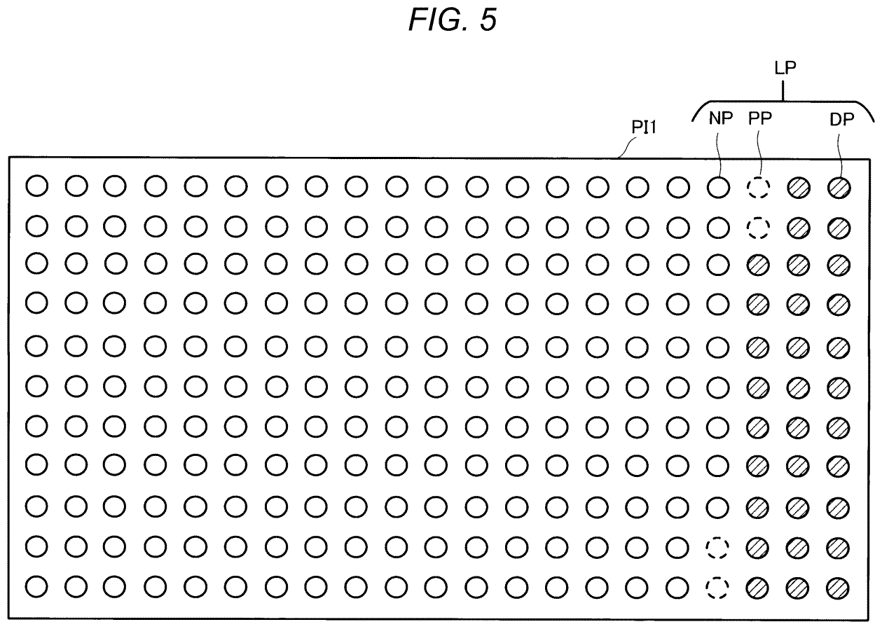

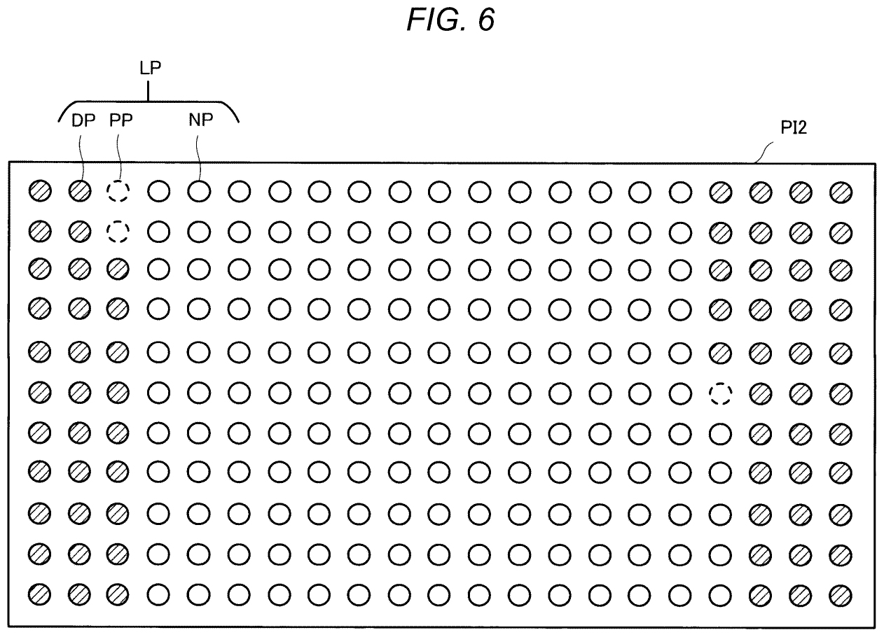

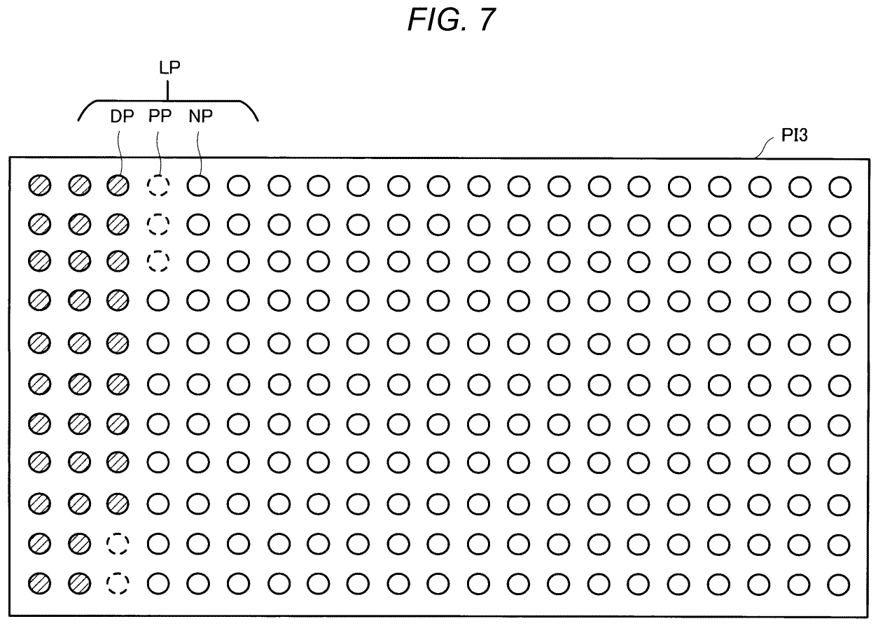

FIGS. 5 to 7 are diagrams illustrating examples of the grid points LP. More specifically, FIG. 5 is an example of the grid points LP corresponding to the projection image PI1 projected from the projection apparatus 10A. FIG. 6 is an example of the grid points LP corresponding to the projection image PI2 projected from the projection apparatus 10B. FIG. 7 is an example of the grid points LP corresponding to the projection image PI3 projected from the projection apparatus 10C.

In FIGS. 5 to 7, the grid points LP include grid points DP, grid points NP, and grid points PP. In these figures, hatched circles indicate the grid points DP included in the overlapped region DR. White circles indicate the grid points NP included in the non-overlapped region NR. Circles with dotted line contours indicate the grid points PP that have not been successfully determined whether being included in the overlapped region DR or included in the non-overlapped region NR. There are measurement values calculated by the image analyzer 133 for the grid points LP illustrated in FIGS. 5 to 7.

The grid point DP is an example of a “first correction point”. The grid point NP is an example of a “second correction point”.

In step S2 in FIG. 4, the projection apparatus 10A projects the measurement pattern for black correction explained above. Specifically, the processing device 13 provided in the projection apparatus 10A functions as the projection controller 131. The processing device 13 reads a measurement pattern from the storage device 14 and causes the projector 11 to sequentially project the measurement pattern onto the projection surface SC.

In step S3, the processing device 13 provided in the projection apparatus 10A functions as the imaging controller 132. The processing device 13 causes the imaging device 12 to image measurement patterns projected onto the projection surface SC. The processing device 13 functions as the image analyzer 133. The processing device 13 analyzes the measurement pattern imaged by the imaging device 12 and calculates a measurement value indicating a color of the measurement pattern in a captured image.

First, the processing device 13 calculates, with interpolation operation, a correspondence relationship between a tone value (r, g, b) of color light serving as a measurement pattern projected by the projector 11 at the points of the grid points LP and a measurement value (R, G, B) indicating a color of the color light in a captured image calculated by analyzing the color light serving as the measurement pattern captured by the imaging device 12. For the interpolation operation, an appropriate calculation only has to be used according to a type and the number of measurement patterns to be used. For example, the processing device 13 may execute curve interpolation using a spline curve. Alternatively, the processing device 13 may execute parabolic interpolation. Alternatively, the processing device 13 may execute cubic curve interpolation. The cubic curve interpolation is, for example, cubic interpolation. The image analyzer 133 multiplies a matrix having, as components, an RGB value indicating a color of color light in an estimated captured image by a conversion matrix specific to the imaging device 12 to convert the RGB value into an XYZ value. As a result, the image analyzer 133 can estimate an output value XYZ for any tone.

Further, the image analyzer 133 converts the estimated XYZ value into a Yu′v′ value using the following Expression 1 to calculate a brightness component Y and a chromaticity component u ‘v’.

$${u}^{′} = \frac{4 X}{X + 15 Y + 3 Z} \cdot {v}^{′} = \frac{9 Y}{X + 15 Y + 3 Z} \qquad [ 1 ]$$

Referring back to FIG. 4, in step S4, the processing device 13 provided in the projection apparatus 10A functions as the correction value calculator 134. The processing device 13 calculates a correction value to be set in each of the brightness correction circuit LC and the color unevenness correction circuit UC such that the brightness of black after correction reaches target brightness when viewed from the imaging device 12, color unevenness of black after the correction is suppressed, and the chromaticity becomes uniform when viewed from the imaging device 12.

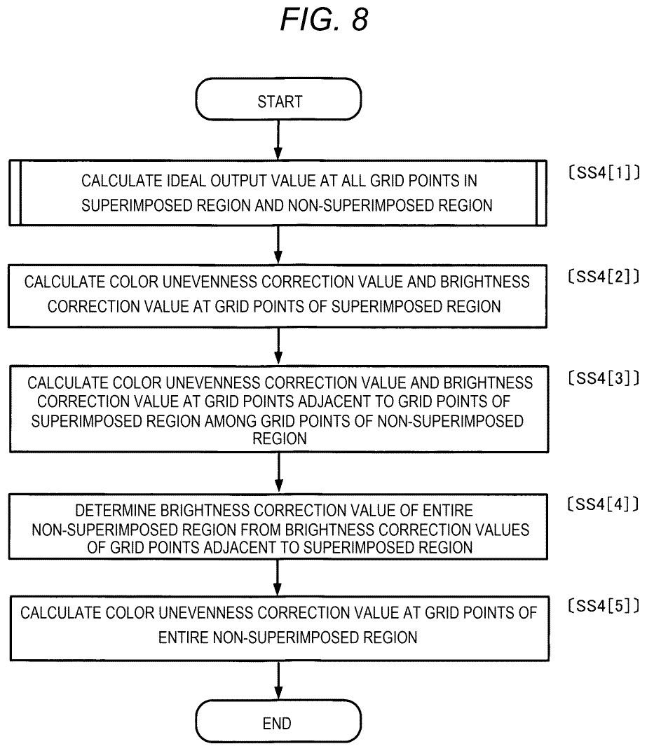

FIG. 8 is a flowchart illustrating sub-steps SS4[1] to SS4[5] configuring step S4.

In sub-step SS4[1], device 13 calculates ideal output values at all the grid points LP in the overlapped region DR and the non-overlapped region NR. Specifically, the processing device 13 calculates an ideal output value for correcting color unevenness in the overlapped region DR as a correction value at the grid points DP included in the overlapped region DR. The processing device 13 calculates, as a correction value at the grid points LP included in the non-overlapped region NR, an ideal value for correcting color unevenness in the non-overlapped region NR and adjusting the brightness of the non-overlapped region NR to the brightness of the overlapped region DR. After these kinds of processing, the processing device 13 decomposes ideal output values at the grid points DP included in the overlapped region DR and the grid points NP included in the non-overlapped region NR into a correction value to be set in the brightness correction circuit LC and a correction value to be set in the color unevenness correction circuit UC. The ideal output value is an example of a “target tone value”.

The method of calculating the “ideal output value” is explained below in a section of “1-3: Supplement (a calculation method for an ideal output value)” explained below.

Here, the brightness correction circuit LC and the color unevenness correction circuit UC are explained.

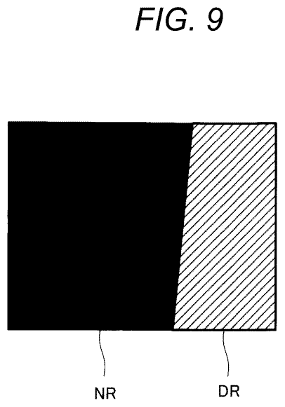

FIG. 9 is a diagram illustrating an example of a correction region of the brightness correction circuit LC. In

FIG. 9, each of the overlapped region DR and the non-overlapped region NR is a correction region to be corrected by the brightness correction circuit LC. The brightness correction circuit LC functions as a circuit that corrects so-called “black floating” when correction is performed on black. The brightness correction circuit LC can set any shape as the correction region as illustrated in FIG. 9. The brightness correction circuit LC can set a brightness correction value C₀ that is a uniform adjustment amount for each of the overlapped region DR and the non-overlapped region NR illustrated in FIG. 9.

On the other hand, the color unevenness correction circuit UC can set a correction value for each of the discrete grid points LP exemplified in FIGS. 5 to 7. The color unevenness correction circuit UC can set a color unevenness correction value S as an adjustment value for each of discrete tones. Here, as an example, the color unevenness correction values S are set for eight tones. Specifically, the color unevenness correction value S at the tone 0 is represented as S₀, the color unevenness correction value S at the tone 146 is represented as S₁, . . . and the color unevenness correction value S at the tone 1023 is represented as S7. Further, the color unevenness correction values S at tones among the tone 0, the tone 146, . . . , and the tone 1023 are determined by linear interpolation.

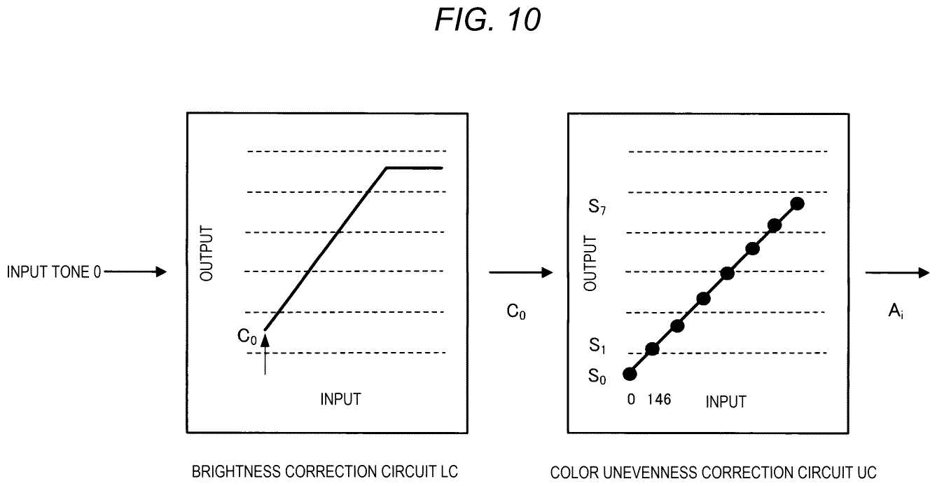

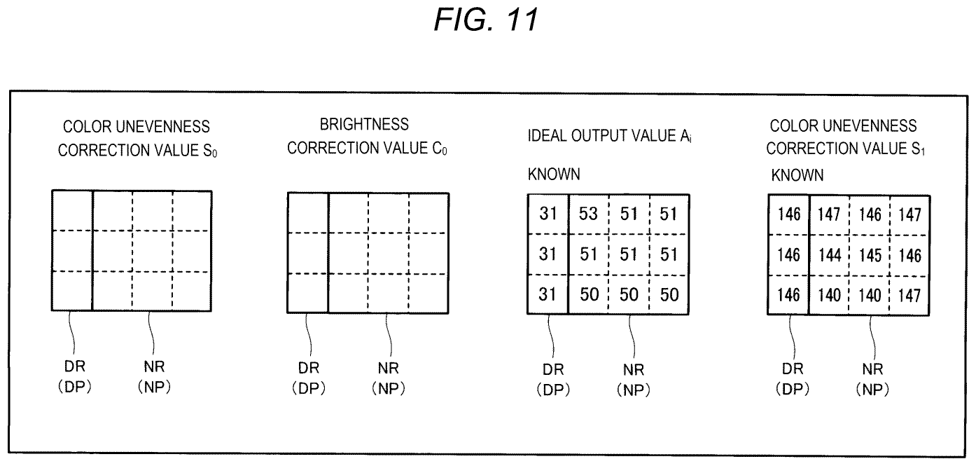

FIG. 10 is a diagram illustrating a processing procedure of the brightness correction circuit LC and the color unevenness correction circuit UC. As illustrated in FIG. 10, when a value of a tone is input to the brightness correction circuit LC, the brightness correction value C₀ is added to the input value. In the case of the tone 0, the brightness correction value output from the brightness correction circuit LC is C₀. When the brightness correction value C₀ for the color unevenness correction circuit UC is output from the brightness correction circuit LC, the color unevenness correction circuit UC linearly interpolates a point where an x coordinate is the tone 0 and a y coordinate is the color unevenness correction value S₀ and a point where an x coordinate is the tone 146 and a y coordinate is the color unevenness correction value S₁, whereby the following Expression 2 is obtained. An output value Aᵤ of the color unevenness correction circuit UC is calculated by the following Expression 2. The color unevenness correction value S₁ has already been calculated in step S1 of FIG. 4.

$${A}_{u} = \frac{{S}_{1} - {S}_{0}}{146 - 0} * {C}_{0} + {S}_{0} \qquad [ 2 ]$$

At the grid point LP, the output value Aᵤ is calculated by using the above Expression 2. A linearly interpolated value is calculated for a pixel between the grid points LP.

FIG. 11 is a diagram illustrating an example of a calculation status of the color unevenness correction value S₀, the brightness correction value C₀, the ideal output value Aᵢ, and the color unevenness correction value S₁ in sub-step SS4[1]. In FIG. 11, for simplification of explanation, it is assumed that the grid points DP included in the overlapped region DR are arranged in one column and three rows and the grid points NP included in the non-overlapped region NR are arranged in three columns and three rows. As illustrated in FIG. 11, at a stage when sub-step SS4[1] is completed, concerning the ideal output value Aᵢ and the color unevenness correction value S₁, values have been calculated at all the grid points DP and NP. On the other hand, values are not calculated at all of the grid points DP and the grid points NP concerning the color unevenness correction value S₀ and the brightness correction value C₀.

Numerical values illustrated in FIG. 11 are integers. However, this is for convenience of explanation. The values corresponding to the grid points DP and the grid points NP may be decimals. The same applies to the drawings referred to below.

In sub-step SS4[2] in FIG. 8, the processing device 13 calculates the color unevenness correction value S₀ and the brightness correction value C₀ at the grid points DP included in the overlapped region DR. Specifically, the processing device 13 divides the ideal output value Aᵢ at the grid point DP included in the overlapped region DR into the color unevenness correction value S₀ and the brightness correction value C₀.

The processing device 13 determines a brightness correction value C₀=C^{Lap} of the overlapped region DR in advance and calculates a color unevenness correction value S₀=S₀^{Lap} at the tone 0 such that the output value Aᵤ, which is the final output value, reaches an ideal output value Aᵢ=A^{Lap}. The brightness correction value C₀=C^{Lap}, the ideal output value Aᵢ=A^{Lap}, and a color unevenness correction value S₁=S₁^{Lap} at the tone 146 are known and when these values are substituted in Expression 2, Expression 3 is obtained. By transforming Expression 3 into Expression 4, a value of the color unevenness correction value S₀=S₀^{Lap} is calculated. In FIG. 11, the ideal output value Aᵢ included in the overlapped region DR is the ideal output value Aᵢ=A^{Lap} explained above.

The color unevenness correction value S₀=S₀^{Lap} of the overlapped region DR is an example of a “first color unevenness correction value”.

$${A}^{Lap} = \frac{{S}_{1}^{Lap} - {S}_{0}^{Lap}}{146 - 0} * {C}^{Lap} + {S}_{0}^{Lap} \qquad [ 3 ]$$

$${S}_{0}^{Lap} = \frac{{S}_{1}^{Lap} {C}^{Lap} - 146 {A}^{Lap}}{{C}^{Lap} - 146} \qquad [ 4 ]$$

Note that the brightness correction value C₀ of the overlapped region DR may be set to C^{Lap}=0 and the color unevenness correction value S₀ of the tone 0 may be set to S₀^{Lap}=A^{Lap}.

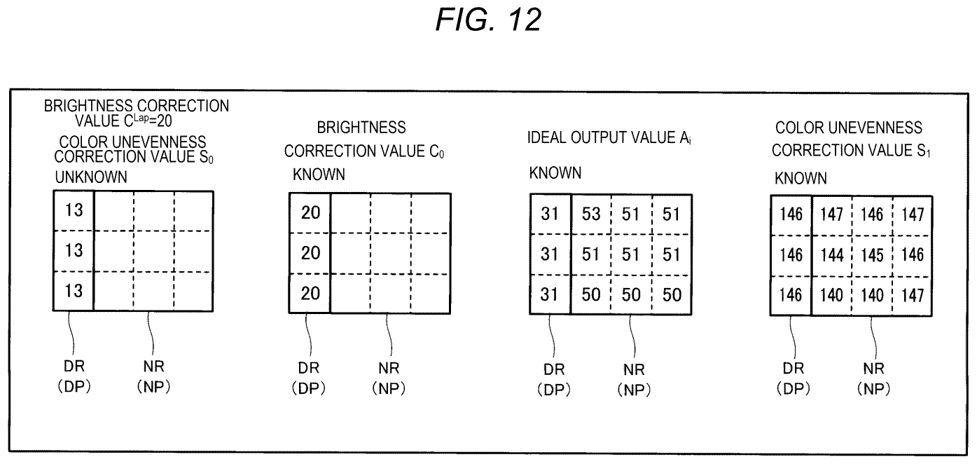

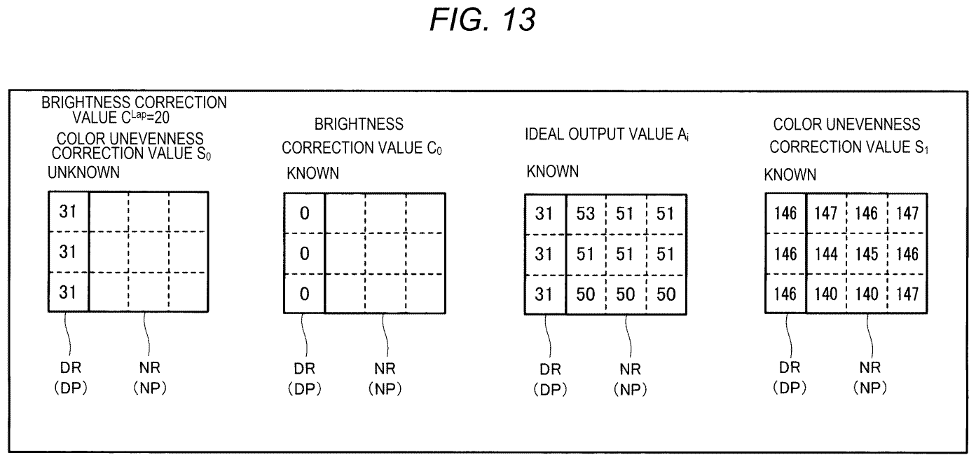

FIGS. 12 and 13 are diagrams illustrating an example of a calculation status of the color unevenness correction value S₀, the brightness correction value C₀, the ideal output value Aᵢ, and the color unevenness correction value S₁ in sub-step SS4[2]. FIG. 12 is a diagram in the case of C^{Lap}=20. FIG. 13 is a diagram in the case of C^{Lap}=0. As illustrated in FIG. 12 and FIG. 13, at a stage when sub-step SS4[2] is completed, concerning the ideal output value At and the color unevenness correction value S₁, values have been calculated at all of the grid points DP and the grid points NP. Concerning the color unevenness correction value S₀ and the brightness correction value C₀, values at the grid points DP included in the overlapped region DR have been calculated.

As explained above, values of the brightness correction value C₀ and the color unevenness correction value So at the grid points DP included in the overlapped region DR are determined at the stage of sub-step SS4[2].

In sub-step SS4[3] in FIG. 8, the processing device 13 calculates the color unevenness correction value S₀ and the brightness correction value C₀ at the grid points NP adjacent to the grid points DP included in the overlapped region DR across the boundary between the non-overlapped region NR and the overlapped region DR among the grid points NP included in the non-overlapped region NR.

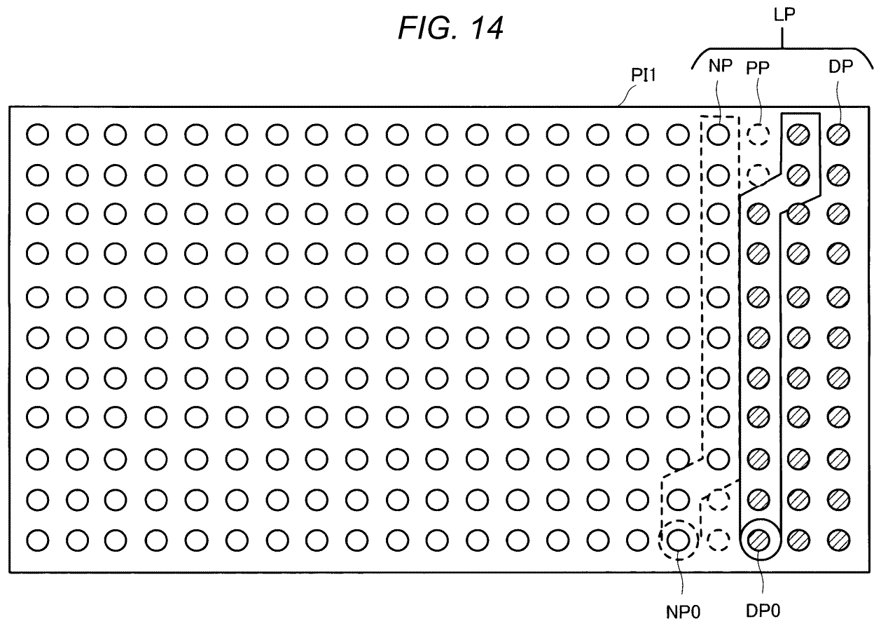

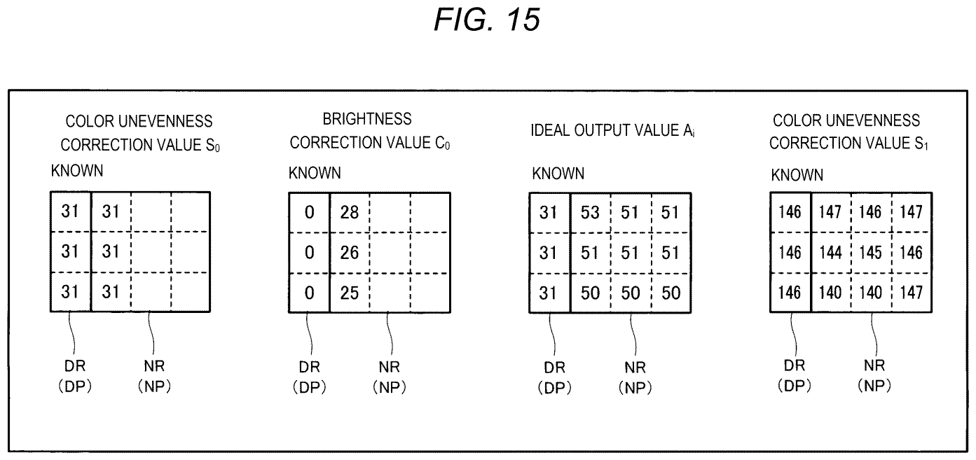

When the grid points DP and the grid points NP are adjacent to each other, the processing device 13 calculates the brightness correction value C₀ of the grid points NP such that the color unevenness correction value S₀ of the tone 0 at the grid points NP is the same value as the color unevenness correction value S₀ of the tone 0 at the grid points DP. FIG. 14 is a diagram of processing content in sub-

step SS4[3]. The projection image PI1 illustrated in FIG. 14 corresponds to the projection image PI1 illustrated in FIG. 5. In FIG. 14, the grid points NP surrounded by a

dotted line are the grid points NP adjacent to the overlapped region DR across the boundary between the non-overlapped region NR and the overlapped region DR. The grid points surrounded by the dotted line is an example of a “third correction point”. In sub-step SS4[3], the processing device 13 calculates a correction value at the grid points NP. The grid points DP surrounded by a solid line are the grid points DP of the overlapped region DR adjacent to the grid points NP.

When calculating the brightness correction value C₀ at a grid point NP0 illustrated in FIG. 14, the processing device 13 calculates a brightness correction value C₀=C^{NonLap} at the grid point NP0 such that the color unevenness correction value S₀ at the grid point NP0 is the same value as the color unevenness correction value S₀=S₀^{Lap} at a grid point DP0. The grid point NP0 and the grid point DP0 are located in the same row of a grid and are adjacent to each other in the row direction. Also when the grid points PP that have not been successfully determined to which of the overlapped region DR and the non-overlapped region NR the grid points PP belong are present between the grid point NP0 and the grid point DP0, the grid point DP0 and the grid point NP0 closest to each other in the row direction or the column direction across the boundary between the non-overlapped region NR and the overlapped region DR are treated as grid points adjacent to each other.

Values of an ideal output value Aᵢ=A^{NonLap}, a color unevenness correction value S₁=S₁^{NonLap} at the tone 146, and the color unevenness correction value S₀=S₀^{Lap} are known and, when these values are substituted in Expression 2, Expression 5 is obtained. A value of the brightness correction value C₀=C^{NonLap} is calculated by transforming Expression 5 into Expression 6.

$${A}^{NonLap} = \frac{{S}_{1}^{NonLap} - {S}_{0}^{Lap}}{146 - 0} * {C}^{NonLap} + {S}_{0}^{Lap} \qquad [ 5 ]$$

$${S}^{NonLap} = \frac{146 ( {A}^{NonLap} - {S}_{0}^{Lap} )}{{S}_{1}^{Lap} - {S}_{0}^{Lap}} \qquad [ 6 ]$$

The processing device 13 executes the same calculation for all the grid points NP surrounded by the dotted line and calculates the brightness correction value C₀=C^{NonLap} of the grid points NP.

FIG. 15 is a diagram illustrating an example of a calculation status of the color unevenness correction value S₀, the brightness correction value C₀, the ideal output value Aᵢ, and the color unevenness correction value S₁ in sub-step SS4[3].

In FIG. 15, the ideal output value Aᵢ of the grid points NP adjacent to the grid points DP among the grid points NP included in the non-overlapped region NR is the ideal output value Aᵢ=A^{NonLap} described above. The color unevenness correction value S₁ of the grid points NP adjacent to the grid points DP among the grid points NP included in the non-overlapped region NR is the color unevenness correction value S₁=S₁^{NonLap} described above. The color unevenness correction value S₀ at the grid points DP included in the overlapped region DR is the S₀=S₀^{Lap} described above. The brightness correction value C₀=C^{NonLap} of the grid points NP adjacent to the grid points DP is calculated by these values and Expression 6.

As illustrated in FIG. 15, at a stage when sub-step SS4[3] is completed, concerning the ideal output value Aᵢ and the color unevenness correction value S₁, values have been calculated at all of the grid points DP and the grid points NP. Concerning the color unevenness correction value S₀ and the brightness correction value C₀, a value at the grid points DP included in the overlapped region DR and a value at the grid points NP adjacent to the grid points DP among the grid points NP included in the non-overlapped region NR have been calculated.

In sub-step SS4[4] in FIG. 8, the processing device 13 uniformly determines the brightness correction value C₀=C^{NonLap} in the entire non-overlapped region NR from the brightness correction value C₀=C^{NonLap} of the grid points NP adjacent to the overlapped region DR across the boundary between the non-overlapped region NR and the overlapped region DR calculated in sub-step SS4[3]. The brightness correction value C₀=C^{NonLap} of the grid points NP adjacent to the overlapped region DR is an example of a “provisional brightness correction value”. As an example, the processing device 13 calculates an average value of the brightness correction values C₀=C^{NonLap} of the grid points NP adjacent to the overlapped region DR across the boundary between the non-overlapped region NR and the overlapped region DR calculated in sub-step SS4[3] and sets the average value as the brightness correction value C₀=C^{NonLap} at all the grid points NP included in the non-overlapped region NR. As explained above with reference to FIG. 9, this is because the brightness correction circuit LC sets the brightness correction value C₀, which is a uniform adjustment amount, for each of the overlapped region DR and the non-overlapped region NR.

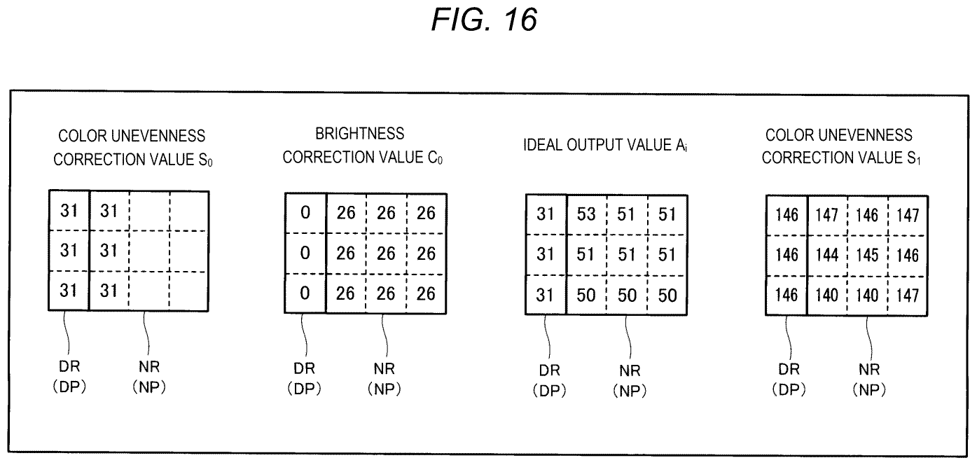

FIG. 16 is a diagram illustrating an example of a calculation status of the color unevenness correction value S₀, the brightness correction value C₀, the ideal output value Aᵢ, and the color unevenness correction value S₁ in sub-step SS4[4]. The average value of the brightness correction values C₀=C^{NonLap} set for the grid points NP adjacent to the overlapped region DR across the boundary between the non-overlapped region NR and the overlapped region DR in FIG. 15 is set as the brightness correction values C₀=C^{NonLap} of all the grid points NP in FIG. 16.

As illustrated in FIG. 16, at a stage when sub-step SS4[4] is completed, concerning the brightness correction value C₀, the ideal output value Aᵢ, and the color unevenness correction value S₁, values have been calculated at all of the grid points DP and the grid points NP. Concerning the color unevenness correction value S₀, a value at the grid points DP included in the overlapped region DR and a value at the grid points NP adjacent to the grid points DP among the grid points NP included in the non-overlapped region NR have been calculated.

In sub-step SS4[5] of FIG. 8, the processing device 13 calculates a color unevenness correction value S₀-S₀^{NonLap′} from the brightness correction value C₀=C^{NonLap} calculated in sub-step SS4[4] at the grid points NP of the entire non-overlapped region NR. The processing in sub-step SS4[5] is also carried out on the grid points NP adjacent to the grid points DP included in the overlapped region DR across the boundary between the non-overlapped region NR and the overlapped region DR for which the brightness correction value C₀=C^{NonLap} is calculated in the sub step SS4[3]. This is because the brightness correction value C₀=C^{NonLap} at the grid point NP has changed through the processing in sub-step SS4[4].

Values of the ideal output value Aᵢ=A^{NonLap}, the color unevenness correction value S₁=S₁^{NonLap} at the tone 146, and the brightness correction value C₀=C^{NonLap} are known and, when these values are substituted in Expression 2, Expression 7 is obtained. By transforming Expression 7 into Expression 8, a value of the color unevenness correction value S₀=S₀^{NonLap′} is calculated.

The color unevenness correction value S₀=S₀^{NonLap′} of the non-overlapped region NR is an example of a “second color unevenness correction value”.

$${A}^{NonLap} = \frac{{S}_{1}^{NonLap} - {S}_{0}^{NonLap ,}}{146 - 0} * {C}^{NonLap} + {S}_{0}^{NonLap} \qquad [ 7 ]$$

$${S}_{0}^{NonLap ,} = \frac{{S}_{1}^{NonLap} {C}^{NonLap} - 146 {A}^{NonLap}}{{C}^{NonLap} - 146} \qquad [ 8 ]$$

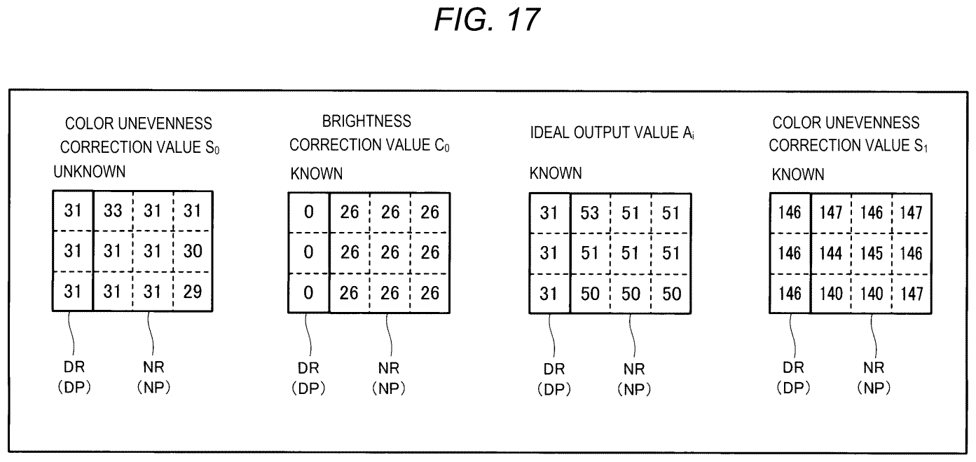

FIG. 17 is a diagram illustrating an example of a calculation status of the color unevenness correction value S₀, the brightness correction value C₀, the ideal output value Aᵢ, and the color unevenness correction value S₁ in sub-step SS4[5].

In FIG. 17, the ideal output value Aᵢ of the grid point NP adjacent to the grid point DP among the grid points NP included in the non-overlapped region NR is the ideal output value Aᵢ=A^{NonLap} described above. The color unevenness correction value S₁ of the grid points NP adjacent to the grid points DP among the grid points NP included in the non-overlapped region NR is the color unevenness correction value S₁=S₁^{NonLap} described above. The brightness correction value C₀ at the grid points NP included in the non-overlapped region NR is C=S₀^{NonLap} described above. The color unevenness correction value S₀=S₀^{NonLap′} is calculated by these values and Expression 8.

As illustrated in FIG. 17, at a stage when sub-step SS4[5] is completed, concerning the color unevenness correction value S₀, the brightness correction value C₀, the ideal output value Aᵢ, and the color unevenness correction value S₁, values have been calculated at all of the grid points DP and the grid points NP.

In step S5 in FIG. 4, the processing device 13 provided in the projection apparatus 10A functions as the correction value calculator 134. The processing device 13 sets the brightness correction value C₀ calculated in step S4 in the brightness correction circuit LC and sets the color unevenness correction value S₀ in the color unevenness correction circuit UC.

In FIG. 2, when tone values of pixels of an image acquired by the image acquirer 135 is input, the brightness correction circuit LC calculates a tone value to be output to the color unevenness correction circuit UC using the brightness correction value C₀. When the tone value calculated by the color unevenness correction circuit UC is input, the color unevenness correction circuit UC outputs the output value Aᵤ of the color unevenness correction circuit UC based on the color unevenness correction value S₀. The output value Aᵤ is a tone value and is input to the projection controller 131. The projection controller 131 converts the output value Aᵤ into a control signal for driving the liquid crystal panel and outputs the control signal to the projector 11. As a result, the projection image PI in which color unevenness of black and “black floating” are corrected is projected from the projector 11 onto the projection surface SC.

### 1-3: Supplement (a Calculation Method for an Ideal Output Value)

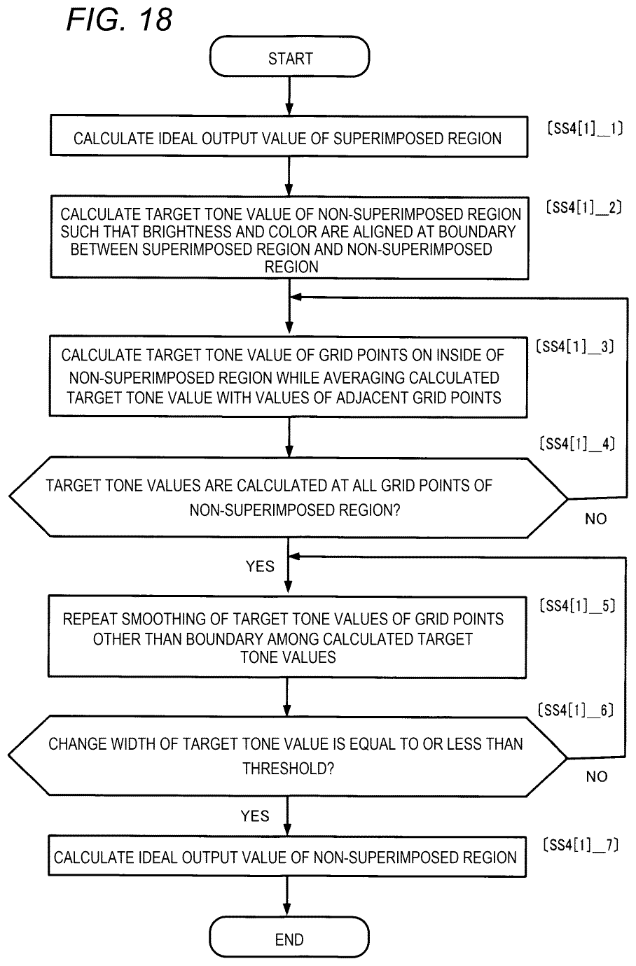

FIG. 18 is a flowchart illustrating sub-steps SS4[1]_1 to SS4[1]_7 configuring sub-step SS4[1]. In the flowchart illustrated in FIG. 18, the processing device 13 first calculates the ideal output value Aᵢ of the overlapped region DR and thereafter calculates target values of the brightness and the chromaticity of the non-overlapped region NR. Thereafter, the processing device 13 calculates the ideal output value Aᵢ in the non-overlapped region NR based on the calculated target value. Here, a “target value of brightness” is a target value for correcting the “black floating” explained above. The “target value of chromaticity” is a target value for correcting the color unevenness explained above.

In the following explanation, for simplicity of explanation, only a calculation method for the ideal output value Aᵢ at the grid points LP included in the projection image PI2 is explained below. However, a calculation method for the ideal output value Aᵢ at the grid point LP included in the projection image PI1 and the projection image PI3 is basically the same.

In sub-step SS4[1]_1, the processing device 13 calculates the ideal output value Aᵢ at the grid points DP included in the overlapped region DR assuming that target brightness and chromaticity in the overlapped region DR are already determined by a known method. The processing device 13 may use a known method as a calculation method for the ideal output value Aᵢ.

Specifically, the processing device 13 determines a target tone value of the overlapped region DR in advance. The processing device 13 calculates, for each of the grid points DP of the overlapped region DR illustrated in FIGS. 5 to 7, the brightness component Y serving as a target value from the determined tone value. The “brightness component Y serving as a target value” is the brightness component Y serving as a target value for correcting the “black floating” explained above.

The processing device 13 calculates, for each of the grid points DP, the brightness component Y serving as the target value. Specifically, even if luminance unevenness is originally present in the overlapped region DR, the processing device 13 does not adjust the luminance unevenness uniformly in the overlapped region DR but calculates, for each of the grid points DP, the brightness component Y serving as the target value. This is because, if the processing device 13 uniformly adjusts the luminance unevenness, it is necessary to reduce the luminance at the grid points DP and, in this case, the number of steps of the tone that can be corrected at the grid points DP decreases. The reason why the processing device 13 determines the brightness component Y serving as the target value for each of the grid points DP in advance is to ensure a correction amount with which color unevenness can be at least uniformly corrected at the grid points DP as explained above.

The processing device 13 determines a chromaticity component u ‘v’ serving as a chromaticity target value of the overlapped region DR in advance. The “chromaticity component u ‘v’ serving as a target value” is a chromaticity component u ‘v’ serving as a target value for correcting the color unevenness. The processing device 13 determines the chromaticity component u ‘v’ as the same target value in all the overlapped regions DR based on average chromaticity among the three projection apparatuses 10 of the projection apparatus 10A, the projection apparatus 10B, and the projection apparatus 10C, average chromaticity in the projection apparatuses 10, a chromaticity design value at the time of product shipment of the projection apparatuses 10, and the like. In this case, after the correction, all the overlapped regions DR have the same chromaticity.

Alternatively, the processing device 13 determines the chromaticity component u ‘v’ as the same target value in the overlapped regions DR based on the parameters explained above. In this case, after the correction, the chromaticity is the same in the overlapped regions DR.

As a result, color unevenness in the overlapped region DR is corrected.

As explained above, the processing device 13 converts a Yu ‘v’ value serving as a target value including the brightness component Y serving as the target value and the chromaticity component u ‘v’ serving as a target value at the grid points DP in the overlapped region DR into an RGB value. Further, the processing device 13 back-calculates the converted RGB value into a target tone value (r, g, b) to be output from the corrector 136 to the projector 11. The processing device 13 sets the target tone value (r, g, b) as the ideal output value Aᵢ that should be output from the corrector 136 to the projector 11. That is, in this paragraph, the ideal output value Aᵢ indicates the target tone value (r, g, b).

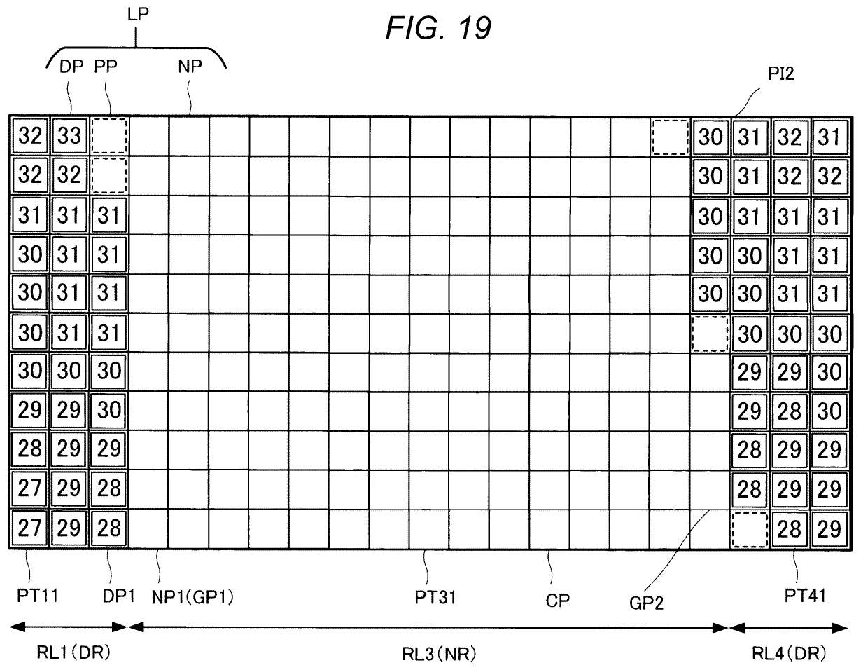

FIG. 19 is a diagram illustrating an example of the target tone value (r, g, b) at the grid points DP calculated by the processing device 13. FIG. 19 illustrates an example of a value of one component among an r component, a g component, and a b component included in the tone value (r, g, b). FIG. 19 corresponds to the projection image PI2 illustrated in FIG. 6.

Rectangles illustrated in FIG. 19 indicates portions PT of the projection image PI including the grid points LP illustrated in FIG. 6. The region RL1 includes a plurality of portions PT11. The region RL3 includes a plurality of portions PT31. The region RL4 includes a plurality of portions PT41.

Numerical values described inside the rectangles are values of one component among the r component, the g component, and the b component included in the target tone value (r, g, b).

For simplification of explanation, numerical values are indicated by integers in FIG. 19. However, actually, the numerical values may be decimals. The same applies to the numerical values illustrated below.

Among the rectangles illustrated in FIG. 19, rectangles, frame lines of which are double lines, correspond to the grid point DP. As explained above, the grid points DP are the grid points LP included in the overlapped region DR. Rectangles, frame lines of which are single lines, correspond to the grid points NP. As explained above, the grid points NP are the grid points LP included in the non-overlapped region NR. Rectangles, frame lines of which are double and one line is a dotted line, correspond to the grid points PP. As explained above, the grid points PP are the grid points LP that has not been successfully determined to which of the overlapped region DR or the non-overlapped region NR the grid points LP belong.

In sub-step SS4[1]_2 of FIG. 18, the processing device 13 determines the target tone value (r, g, b) at the grid points NP such that brightness and a color are aligned between the grid point DP belonging to the overlapped region DR and the grid point NP belonging to the non-overlapped region NR adjacent to each other across the boundary between the overlapped region DR and the non-overlapped region NR.

The target tone value (r, g, b) at the grid points NP is calculated based on the target tone value (r, g, b) at the grid points DP. Hereinafter, a specific calculation method is explained.

In FIG. 19, a grid point DP1 is an example of the grid points DP. A grid point NP1 is an example of the grid points NP. The grid point DP1 and the grid point NP1 are adjacent to each other with across the boundary between the overlapped region DR and the non-overlapped region NR.

In FIG. 19, the target tone value (r, g, b) of the grid point DP1 has already been calculated. The processing device 13 estimates an RGB value serving as a measurement value measured by the imaging device 12 based on the tone value (r, g, b). The processing device 13 converts the RGB value serving as the estimated measurement value into an XYZ value. Further, the processing device 13 further converts the converted XYZ value into a Yu ‘v’ value by applying Expression 1 described above to the converted XYZ value.

Accordingly, since the Yu ‘v’ value of the grid point DP1 is calculated, the processing device 13 sets the Yu ‘v’ value as a Yu ‘v’ value serving as a target value of the grid point NP1. Further, the processing device 13 calculates a target tone value (r, g, b) of the grid point NP1 based on the Yu′ v value serving as the target value.

In FIG. 19, the region RL3 includes a plurality of intermediate portions CP between a first adjacent portion GP1 and a second adjacent portion GP2.

In the following explanation, for simplification of explanation, a target value of brightness among target values of the grid point NP1 is explained. Since a calculation method for a target value of chromaticity is the same as a calculation method for a target value of brightness, explanation concerning the target value of brightness is applied to the target value of chromaticity as well.

When the brightness of the grid point NP1 is the target value, the processing device 13 calculates, as a target tone value (r, g, b) of the grid points NP, the tone value t that makes an r component, a g component, and a b component are (r, g, b)=(t, t, t). Specifically, when the projector 11 projects colored light of gray, the processing device 13 calculates the tone value t that makes brightness the same at the grid point DP1 and the grid point NP1.

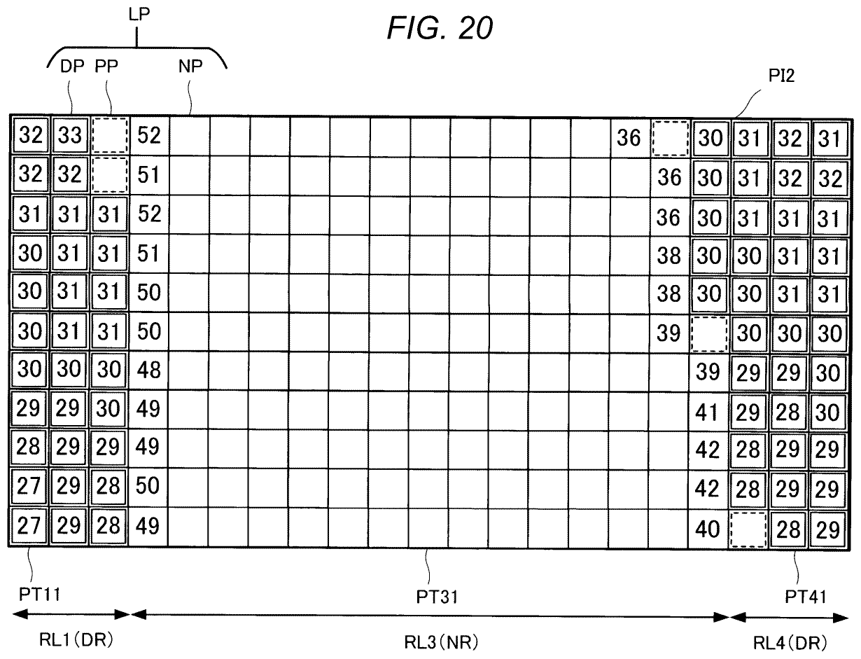

FIG. 20 is a diagram illustrating an example of a target tone value (r, g, b) at the grid points DP and the target tone value t at the grid points NP adjacent to the boundary between the overlapped region DR and the non-overlapped region NR.

When the correction is not performed, since the non-overlapped region NR is darker than the overlapped region DR, in order to make the brightness component Y the same in the overlapped region DR and the non-overlapped region NR after the correction, it is necessary to make the target tone value t at the grid points NP larger than the target tone value (r, g, b) at the grid points DP.

In sub-step SS4[1] 3 in FIG. 18, the processing device 13 calculates the target tone value t of the more grid points NP by averaging the target tone value t of the grid points NP calculated in sub-step SS4[1]_2 with the target tone value t of the adjacent grid point NP.

Specifically, for the grid point NP for which the target tone value t has not been determined, if there are one or more grid points NP for which the target tone value t has been determined among the grid points NP adjacent to the grid point NP in the up-down and left-right directions, the processing device 13 calculates an average value of the target tone values t of these grid points NP. The processing device 13 sets the calculated average value as the target tone value t of the grid point NP for which the target tone value t has not been determined.

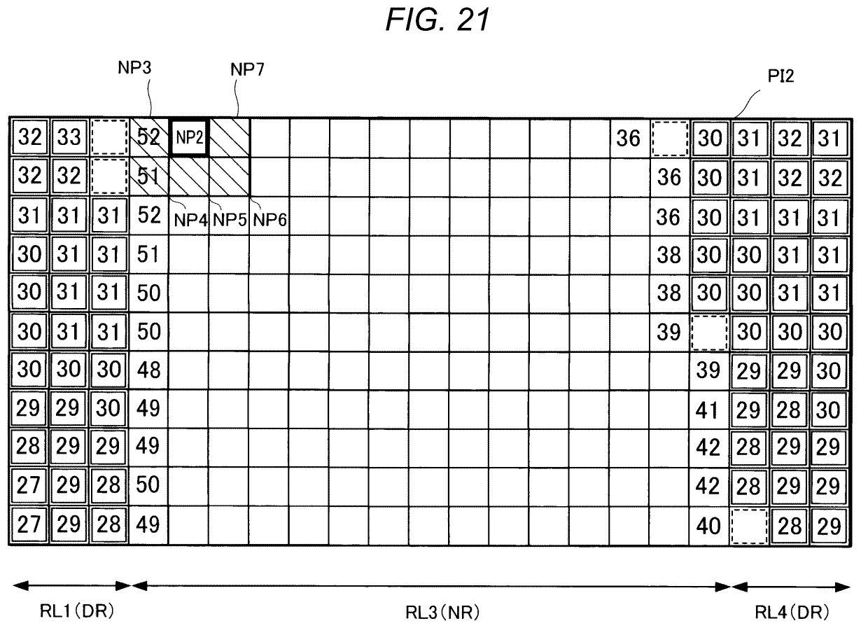

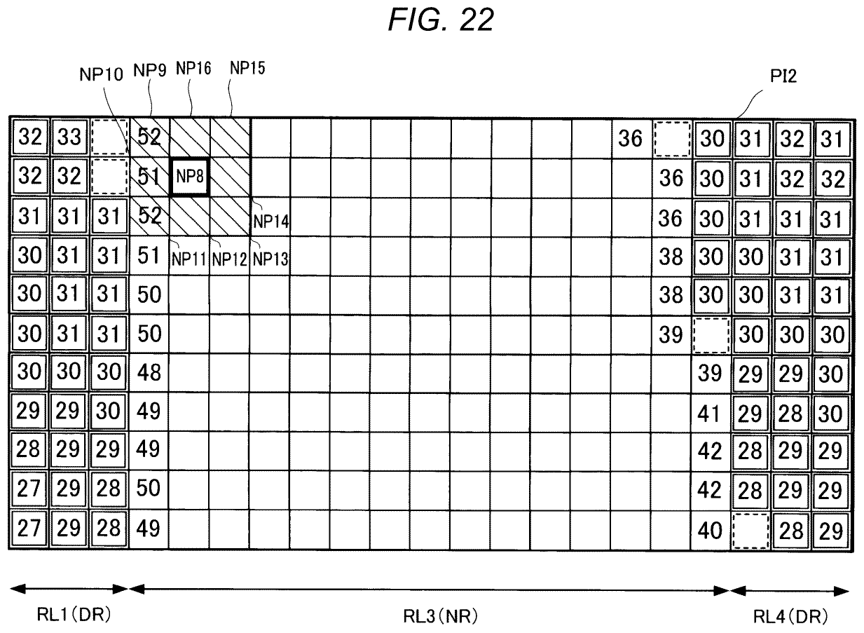

FIGS. 21 and 22 are diagrams illustrating an example of a method of determining the tone value t of a target value of the grid point NP for which the target tone value t has not been determined.

In FIG. 21, a grid point NP2 for which the target tone value t has not been determined is located at an end portion of the non-overlapped region NR. In this case, as the grid points NP adjacent to the grid point NP2, there are five grid points NP of a grid point NP3 to a grid point NP7. The target tone value t=52 is set for the grid point NP3 among the grid points NP3 to NP7. The target tone value t=51 is set for the grid point NP4. On the other hand, the target tone value t is not set for the grid points NP5 to NP7. For this reason, the processing device 13 sets an average value of the target tone value t=52 of the grid point NP3 and the target tone value t=51 of the grid point NP4 as the target tone value t of the grid point NP2.

In FIG. 22, a grid point NP8 for which the target tone value t has not been determined is located on the inner side of the non-overlapped region NR. In this case, there are eight grid points NP of a grid point NP9 to a grid point NP16 as the grid points NP adjacent to the grid point NP8. Among these eight grid points NP, the target tone value t=52 is set for the grid point NP9. The target tone value t=51 is set for the grid point NP10. The target tone value t=52 is set for the grid point NP11. On the other hand, the target tone value t is not set for the grid points NP12 to NP16. For this reason, the processing device 13 sets an average value of the target tone value t=52 of the grid point NP9, the target tone value t=51 of the grid point NP10, and the target tone value t=52 of the grid point NP11 as the target tone value t of the grid point NP8. In sub-step SS4[1]_4 in FIG. 18, the processing

device 13 determines whether the target tone value t has been calculated at all the grid points NP included in the non-overlapped region NR. When the target tone value t has been calculated at all the grid points NP in the non-overlapped region NR (“YES” in sub-step SS4[1]_4), the processing device 13 executes the processing of sub-step SS4[1]_5. On the other hand, when the target tone value t has not been calculated at all the grid points NP in the non-overlapped region NR (“NO” in sub-step SS4[1]_4), the processing device 13 executes the processing of sub-step SS4[1]_4.

As a result, the processing device 13 sequentially extends the grid point NP for which the target tone value t is calculated to the inside of the non-overlapped region NR.

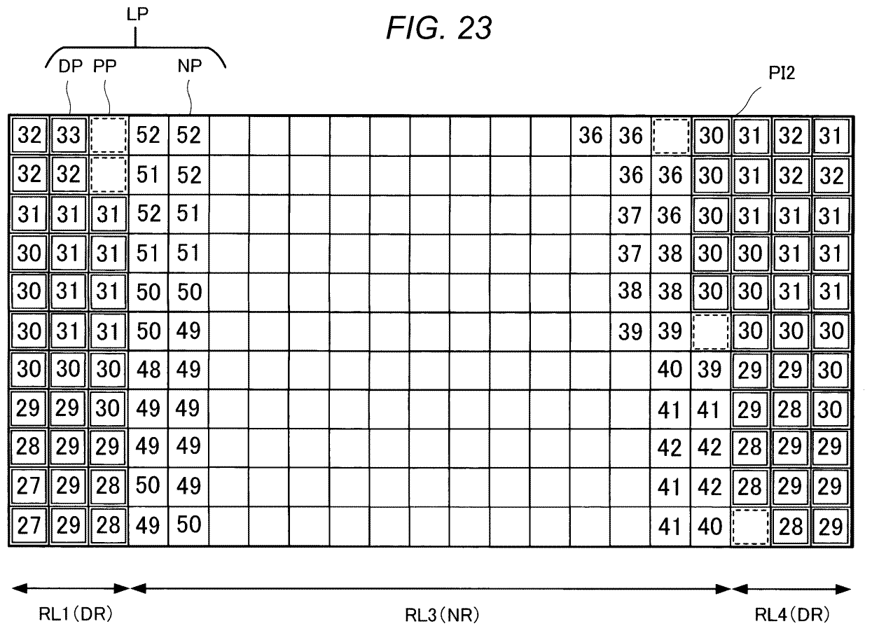

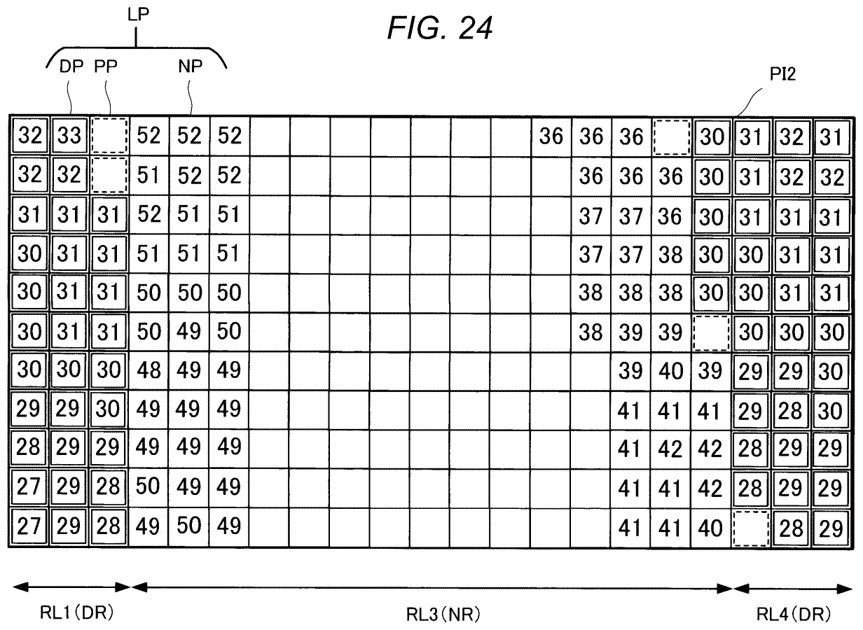

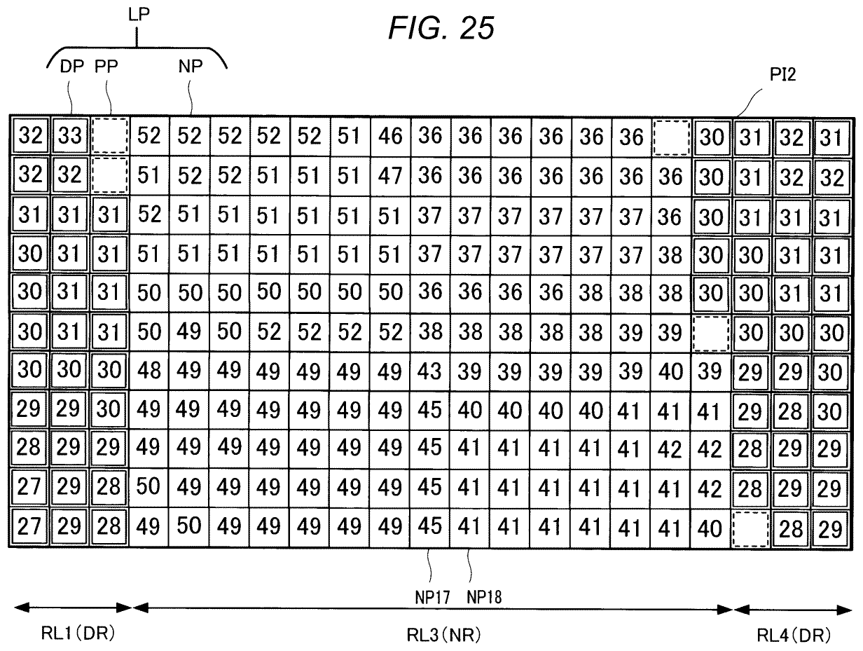

FIGS. 23 to 25 are diagrams illustrating examples of a calculation status of the target tone value t. More specifically, compared with the state of FIG. 22, FIG. 23 is a diagram illustrating a calculation status of the target tone value t of the grid points NP adjacent to the grid points NP adjacent to the boundary between the overlapped region DR and the non-overlapped region NR in the inner side direction of the non-overlapped region NR. FIG. 24 is a diagram illustrating a calculation status of the target tone value t of the grid points NP adjacent to the grid points NP for which the target tone value t is calculated anew in FIG. 23 in the inner side direction of the non-overlapped region NR. FIG. 25 is a diagram illustrating a status in which the target tone values t of all the grid points NP are calculated.

In sub-step SS4[1]_5 in FIG. 18, the processing device 13 repeats smoothing of the target tone value t of the grid points NP other than the grid points NP adjacent to the boundary between the overlapped region DR and the non-overlapped region NR among the calculated target tone values t. Specifically, the processing device 13 smooths the grid points NP other than the grid points NP adjacent to the boundary using the target tone value t of the effective grid points NP among the grid points NP adjacent in the up-down and left-right directions.

As illustrated in FIG. 25, when calculating the target tone value t of the grid points NP, as explained above, the processing device 13 sequentially calculated, from the region RL1, which is a first overlapped region DR, the target tone value t of the grid points NP on the inner side of the non-overlapped region NR, that is, adjacent to the grid points NP in the right direction. In parallel to this, the processing device 13 sequentially calculated, from the region RL4, which is a second overlapped region DR, the target tone value t of the grid points NP adjacent to the inner side of the non-overlapped region NR, that is, the left direction. For this reason, in FIG. 25, as an example, a large difference occurs between the target tone value t=45 of a grid point NP17 and the target tone value t=41 of a grid point NP18 adjacent to the grid point NP17. In other words, a level difference occurs between the target tone value t=45 of the grid point NP17 and the target tone value t=41 of the grid point NP18.

The processing device 13 performs the smoothing explained above such that the level difference of the interpolated target tone values t is eliminated and the target tone values t of the grid points NP included in the non-overlapped region NR are smoothly connected from the region RL1, which is the first overlapped region DR, toward the region RL4, which is the second overlapped region DR.

As a result, as explained below, a distribution of the target tone value t of the region RL3, which is the non-overlapped region NR, becomes a continuous or step-by-step distribution in the direction from the region RL1 to the region RL4.

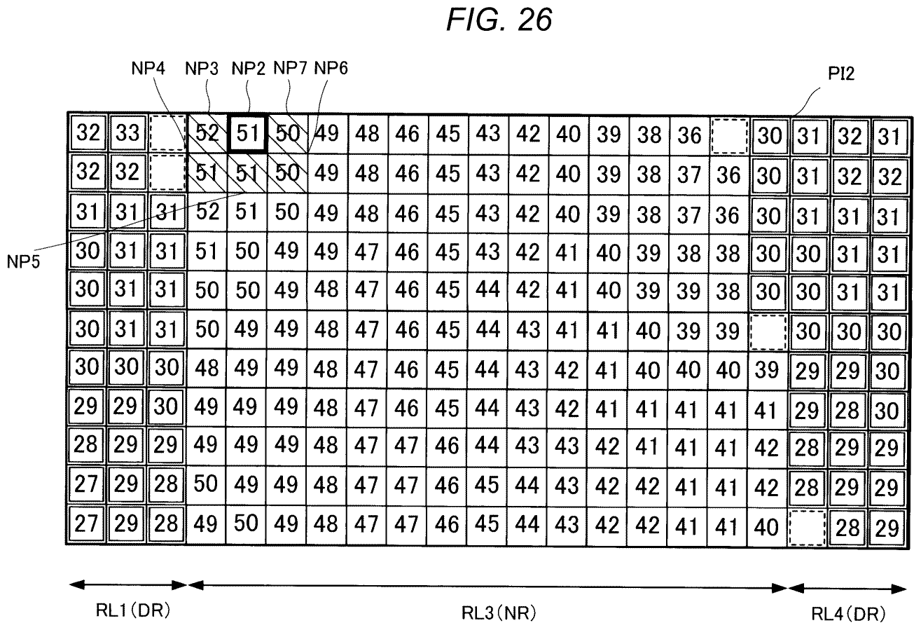

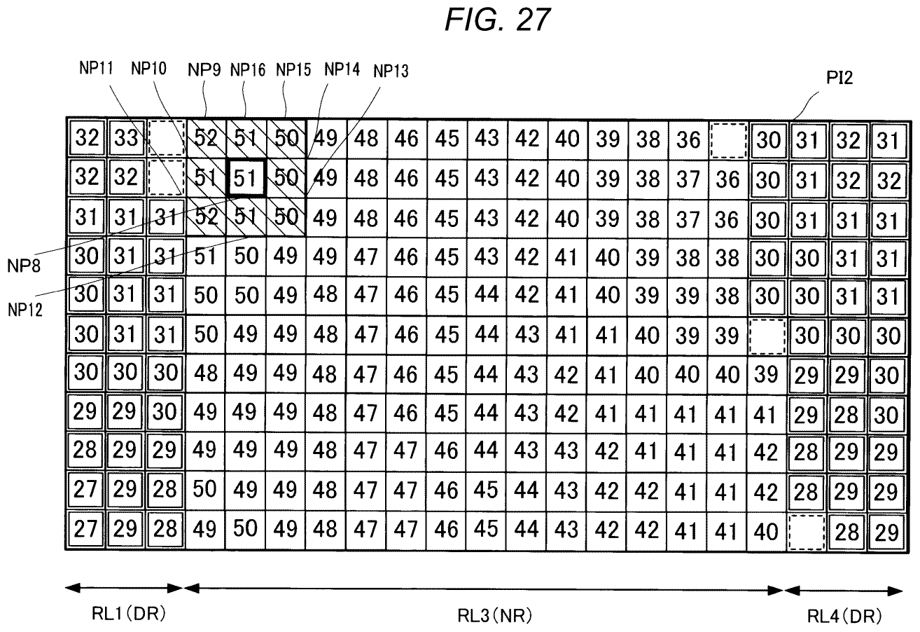

FIGS. 26 and 27 are diagrams illustrating an example of smoothing. FIG. 26 corresponds to FIG. 21. FIG. 27 corresponds to FIG. 22.

In FIG. 26, the processing device 13 smooths the target tone value t=51 of the grid point NP2 using the target tone value t=52 of the grid point NP3, the target tone value t=51 of the grid point NP4, the target tone value t=51 of the grid point NP5, the target tone value t=50 of the grid point NP6, and the target tone value t=50 of the grid point NP7.

In FIG. 27, the processing device 13 smooths the target tone value t=51 of the grid point NP8 using the target tone value t=52 of the grid point NP9, the target tone value t=51 of the grid point NP10, the target tone value t=52 of the grid point NP11, the target tone value t=51 of the grid point NP12, the target tone value t=50 of the grid point NP13, the target tone value t=50 of the grid point NP14, the target tone value t=50 of the grid point NP15, and the target tone value t=51 of the grid point NP16.

In sub-step SS4[1]_6 of FIG. 18, the processing device 13 determines whether a change width of the target tone value t of the grid points NP is equal to or less than a threshold before and after the smoothing. More specifically, the processing device 13 determines whether a sum of change widths of the target tone values t of all the grid points NP is equal to or less than the threshold. When the sum of the change widths of the target tone values t of all the grid points NP is equal to or less than the threshold (“YES” in sub-step SS4[1]_6), the processing device 13 executes processing in sub-step SS4[1]_7. On the other hand, when the sum of the change widths of the target tone values t of all the grid points NP exceeds the threshold (“NO” in sub-step SS4[1]_6), the processing device 13 executes processing in sub-step SS4[1]_5.

That is, the processing device 13 repeats the smoothing until the sum of the change widths of the target tone values t of all the grid points NP becomes equal to or less than the threshold.

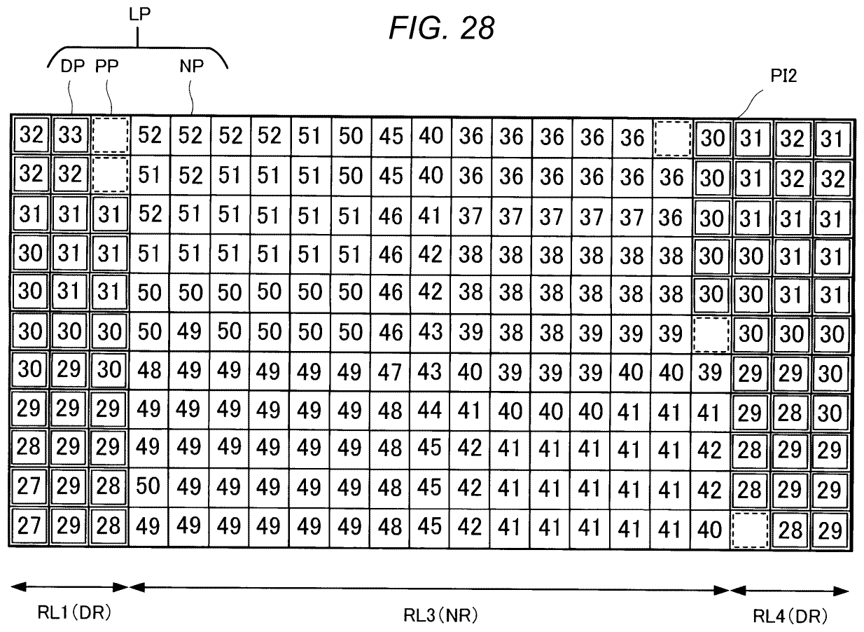

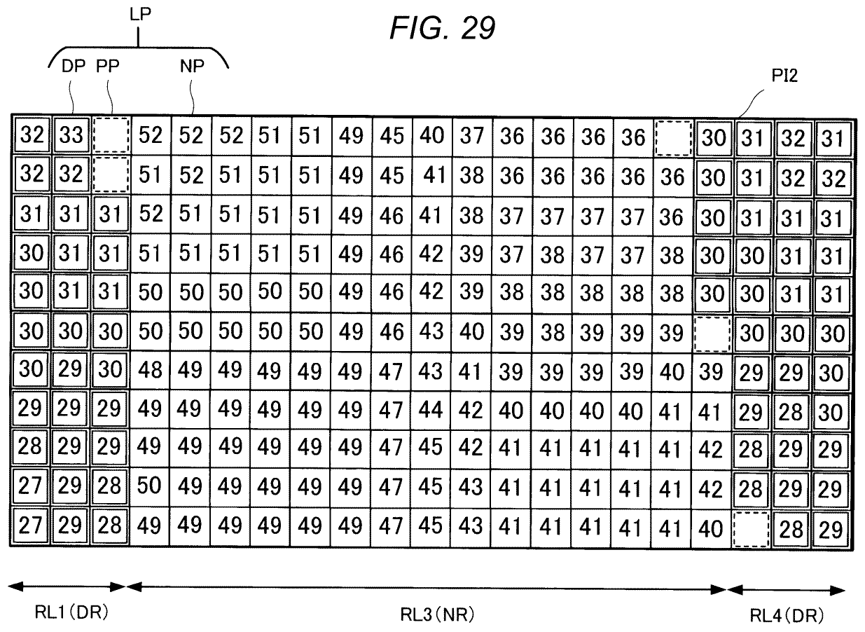

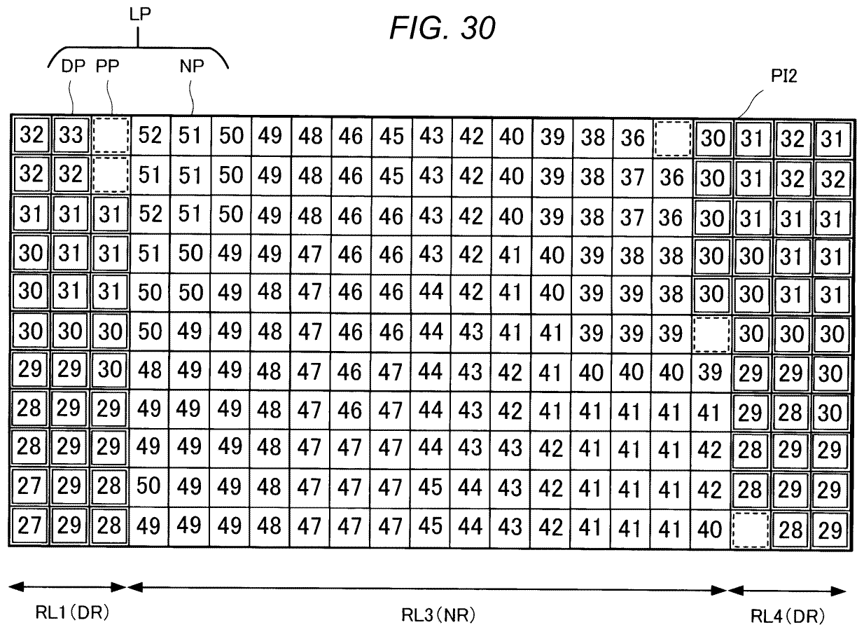

FIGS. 28 to 30 are diagrams illustrating an example of a status of smoothing of the target tone value t. More specifically, FIG. 28 is a diagram illustrating an example of the target tone value t after first smoothing processing. FIG. 29 is a diagram illustrating an example of the target tone value t after second smoothing processing. FIG. 30 is a diagram illustrating an example of the target tone value t after eighteenth smoothing processing. It is assumed that the smoothing is completed through the eighteenth smoothing processing illustrated in FIG. 30.

As it is evident when FIGS. 28 to 30 are compared, as the number of times of the smoothing processing increases, a difference in the target tone value t between the grid points NP adjacent to each other decreases as a whole.

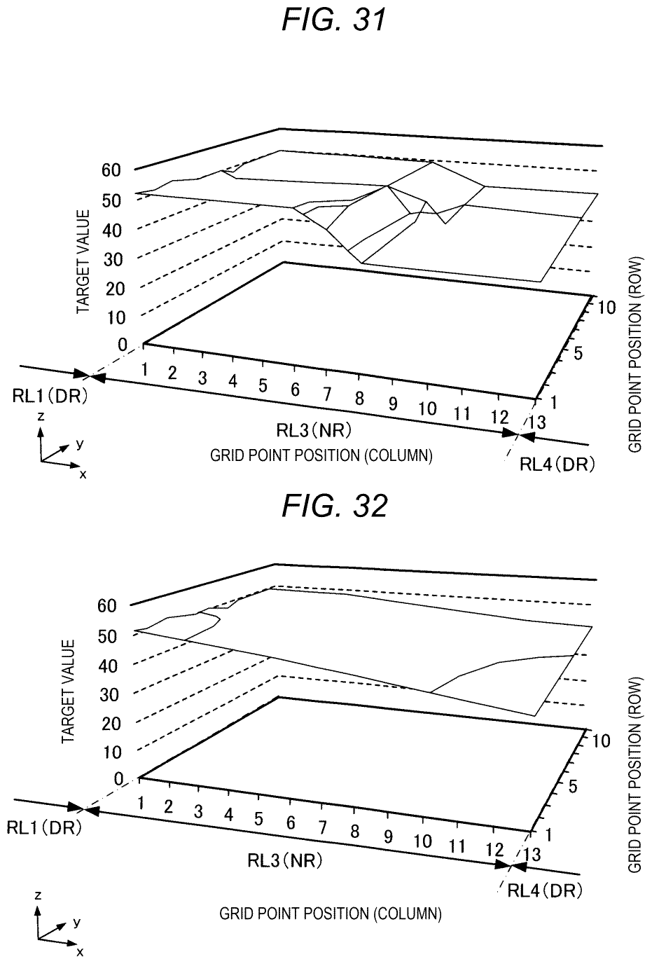

FIG. 31 is a diagram illustrating three-dimensional display of the target tone values t of the grid points NP before smoothing. FIG. 32 is a diagram illustrating three-dimensional display of the target tone values t of the grid points NP after the smoothing is completed. In both of FIGS. 31 and 32, an x axis indicates a position in a column direction of the grid point NP. A y axis indicates a position in a row direction of the grid point NP. A z axis indicates the target tone value t.

As it is evident when FIGS. 31 and 32 are compared, after the smoothing is completed, a level difference of the target tone values t is eliminated as compared with before the smoothing.

The processing device 13 functions as the correction value calculator 134 in sub-step SS4[1]_7 in FIG. 18. The processing device 13 calculates a target tone value (r, g, b) at the grid points NP included in the non-overlapped region NR. As explained above, the processing device 13

determines a target tone value (t, t, t) of the brightness at the grid points NP after the smoothing is completed by the processing up to sub-step SS4[1]-6. The processing device 13 calculates the target tone value (r, g, b) at the grid points NP based on the tone value (t, t, t). The processing device 13 may use a known method as a calculation method for the target tone value (r, g, b).

Specifically, the processing device 13 calculates a brightness component from the target tone value (t, t, t). The processing device 13 sets the calculated brightness component as the brightness component Y of a target value.

As explained above, the processing device 13 determines the chromaticity component u ‘v’ of a target value in the same manner as the brightness component Y of the target value at the grid points NP.

The processing device 13 converts a Yu ‘v’ value serving as a target value at the grid points NP in the non-overlapped region NR into an RGB value. Further, the processing device 13 back-calculates the converted RGB value into a target tone value (r, g, b) to be output from the corrector 136 to the projector 11.

The processing device 13 sets the target tone value (r, g, b) at the grid points DP and the grid points NP as the ideal output value Aᵢ.

### 2: Modifications

The embodiment explained above can be variously modified. Specific aspects of the modifications are exemplified below. The aspects exemplified below and the aspects explained in the embodiment above can be combined with each other as appropriate within a range in which the aspects do not contradict each other. Note that, in the modifications exemplified below, elements having effects and functions equivalent to those in the embodiment are denoted by the reference numerals and signs referred to in the above description and detailed explanation of the elements is omitted as appropriate.

### 2-1: Modification 1

In the embodiment explained above, the projection system 1 includes the three projection apparatuses 10 of the projection apparatus 10A to the projection apparatus 10C and calculates the correction values at the grid points DP included in the overlapped region DR and the grid points NP included in the non-overlapped region NR in the case in which the three projection apparatuses 10 are disposed side by side in one direction.

However, the projection system 1 may include another number of projection apparatuses 10. Images projected from the plurality of projection apparatuses 10 are not limited to an aspect in which the images are arranged in one direction. For example, two or more projection apparatuses 10 only have to be provided and the images may be arranged in all of the up and down and the left and right directions and may be arranged in a matrix such as in two rows and two columns or three rows and three columns.

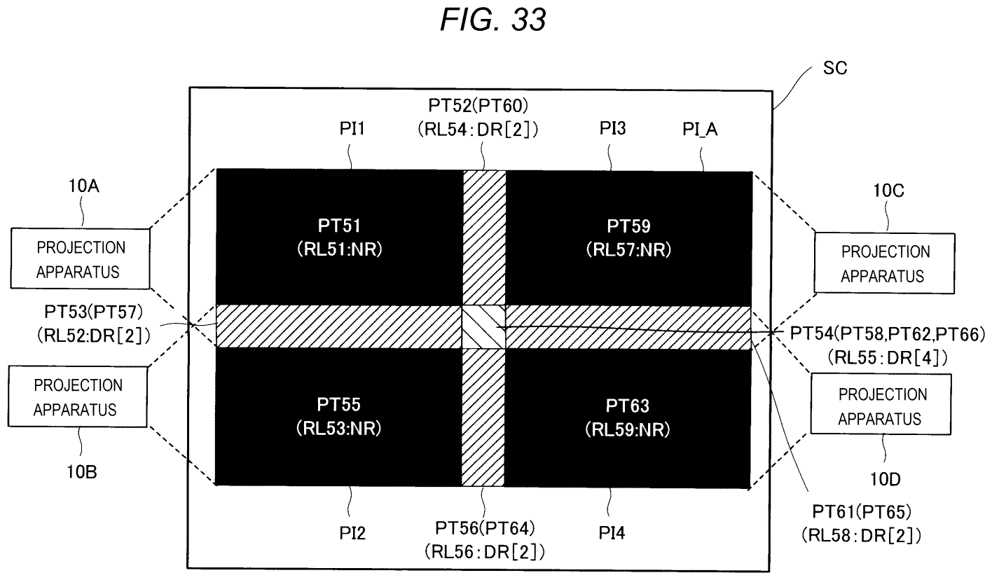

FIG. 33 is a diagram of the projection image PI_A in the case in which the projection apparatuses 10 are disposed in two rows and two columns. In an example illustrated in FIG. 33, the projection apparatus 10A projects the projection image PI1 onto the projection surface SC. The projection apparatus 10B projects a projection image PI2 onto the projection surface SC. The projection apparatus 10C projects a projection image PI3 onto the projection surface SC. A projection apparatus 10D projects a projection image PI4 onto the projection surface SC. The projection image PI1, the projection image PI2, the projection image PI3, and the projection image PI14 are projected onto the projection surface SC to be partially overlapped on one another, whereby one projection image PI_A is displayed as a whole on the projection surface SC.

Specifically, the projection image PI1 includes a portion PT51, a portion PT52, a portion PT53, and a portion PT54. The projection image PI2 includes a portion PT55, a portion PT56, a portion PT57, and a portion PT58. The projection image PI3 includes a portion PT59, a portion PT60, a portion PT61, and a portion PT62. The projection image PI4 includes a portion PT63, a portion PT64, a portion PT65, and a portion PT66.

The portion PT53 of the projection image PI1 and the portion PT57 of the projection image PI2 are projected onto the projection surface SC to be overlapped. The portion PT52 of the projection image PI1 and the portion PT60 of the projection image PI3 are projected onto the projection surface SC to be overlapped. The portion PT61 of the projection image PI3 and the portion PT65 of the projection image PI4 are projected onto the projection surface SC to be overlapped. The portion PT56 of the projection image PI2 and the portion PT64 of the projection image PI4 are projected onto the projection surface SC to be overlapped. The portion PT54 of the projection image PI1, the portion PT58 of the projection image PI2, the portion PT62 of the projection image PI3, and the portion PT66 of the projection image PI4 are projected onto the projection surface SC to be overlapped.

As a result, the region RL51 of the projection image PI_A includes only the portion PT51 of the projection image PI1. The region RL52 of the projection image PI_A includes the portion PT53 of the projection image PI1 and the portion PT57 of the projection image PI2. The region RL53 of the projection image PI_A includes only the portion PT55 of the projection image PI2. The region RL54 of the projection image PI_A includes the portion PT52 of the projection image PI1 and the portion PT60 of the projection image PI3. The region RL55 of the projection image PI_A includes the portion PT54 of the projection image PI1, the portion PT58 of the projection image PI2, the portion PT62 of the projection image PI3, and the portion PT66 of the projection image PI4. The region RL56 of the projection image PI_A includes the portion PT56 of the projection image PI2 and the portion PT64 of the projection image PI3. The region RL57 of the projection image PI_A includes only the portion PT59 of the projection image PI3. The region RL58 of the projection image PI_A includes the portion PT61 of the projection image PI3 and the portion PT65 of the projection image PI4. The region RL59 of the projection image PI_A includes only the portion PT63 of the projection image PI4.

In the projection image PI_A, the region RL51, the region RL53, the region RL57, and the region RL59 are non-overlapped regions NR. The region RL52, the region RL54, the region RL56, and the region RL58 are double overlapped regions DR[2]. The region RL55 is a quadruple overlapped region DR[4].

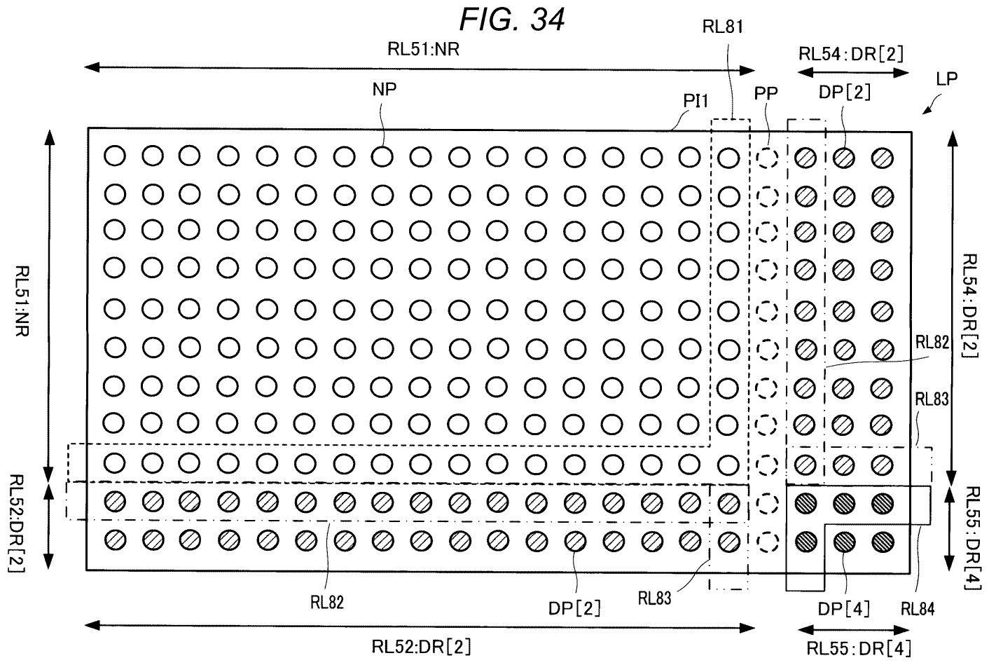

FIG. 34 illustrates the grid points LP included in each of the non-overlapped region NR, the double overlapped region DR[2], and the quadruple overlapped region DR[4] in the projection image PI1. The non-overlapped region NR includes the grid points NP. The double overlapped region DR[2] includes grid points DP[2]. The quadruple overlapped region DR[4] includes grid points DP[4].

In FIG. 34, a region RL81 surrounded by a dotted line includes the grid points NP adjacent to the grid points DP[2]. A region RL82 surrounded by an alternate long and short dash line includes the grid points DP[2] adjacent to the grid points NP. A region RL83 surrounded by an alternate long and two short dashes line includes the grid points DP[2] adjacent to the grid points DP[4]. A region RL84 surrounded by a solid line includes the grid points DP[4] adjacent to the grid points DP[2].

Here, “adjacent” includes a case of being adjacent with the grid points PP interposed therebetween.

In this modification, the processing device 13 executes the same processing as the processing in sub-step SS4[1] to sub-step SS4[5] illustrated in FIG. 18. In the following explanation, differences of sub-step SS4[1] to sub-step SS4[5] according to this modification from sub-step SS4[1] to sub-step SS4[5] according to the embodiment explained above are mainly explained.

Generally, in sub-step SS4[1] in this modification, the processing device 13 calculates the ideal output value Aᵢ for all the grid points LP with the same processing as the processing in sub-step SS4[1] in the embodiment explained above. Subsequently, in sub-step SS4[2] to sub-step SS4[5] in the embodiment explained above, the processing device 13 executes processing in which each of the “non-overlapped region NR” and the “overlapped region DR” in the embodiment explained above is replaced with each of the “double overlapped region DR[2]” and the “quadruple overlapped region DR[4]”. Finally, in sub-steps SS4[3] to SS4[5] in the embodiment explained above, the processing device 13 executes processing in which the “non-overlapped region NR” and the “overlapped region DR” in the embodiment explained above are replaced with the “non-overlapped region NR” and the “double overlapped region DR[2]”.

Specifically, in this modification, the processing device 13 executes, on the quadruple overlapped regions DR[2], the processing for the overlapped region DR in sub-step SS4[2] in the embodiment explained above. That is, the processing device 13 decomposes the ideal output value Aᵢ of the quadruple overlapped region DR[4] into the brightness correction value C₀ and the color unevenness correction value S₀.

Further, in this modification, in the same processing as sub-step SS4[3] in the embodiment explained above, the processing device 13 calculates the brightness correction value C₀ such that, for the grid points DP[2] included in the region RL83, which is the boundary portion with the quadruple overlapped region DR[4] in the double overlapped region DR[2], the color unevenness correction value S₀ of the tone 0 is the same value as the color unevenness correction value S₀ of the grid points DP[4] included in the quadruple overlapped region DR[4].

In this modification, in the same processing as that in sub-step SS4[4] in the embodiment explained above, the processing device 13 calculates an average value of the brightness correction values CO of the grid points DP[2] included in the region RL83 and sets the average value as the brightness correction value C₀ uniformly set for the grid points DP[2] included in the region RL82 and the region RL83.

In this modification, in the same processing as sub-step SS4[5] in the embodiment explained above, the processing device 13 executes, on the grid points DP[2] included in the double overlapped region DR[2], the same processing as the calculation of the color unevenness correction value S₀ at the grid points NP included in the non-overlapped region NR.

Thereafter, the processing device 13 calculates the brightness correction value C₀ and the color unevenness correction value S₀ at the grid points NP included in the non-overlapped region NR in the same procedure as the procedure in sub-step SS4[3] to sub-step SS4[5] in the embodiment explained above.

### 2-2: Modification 2

In sub-step SS4[4] in the embodiment explained above, the processing device 13 calculates the average value of the brightness correction values C₀=C^{NonLap} of the grid points NP adjacent to the overlapped region DR across the boundary between the non-overlapped region NR and the overlapped region DR and sets the average value as the brightness correction value C₀=C^{NonLap} at all the grid points NP included in the non-overlapped region NR. However, the processing device 13 may calculate a median value, a mode value, a maximum value, and a minimum value instead of the average value. The processing device 13 generally calculates the brightness correction values C₀=C^{NonLap} at all the grid points NP included in the non-overlapped region NR by statistically processing provisional brightness correction values of the grid points NP adjacent to the overlapped region DR across the boundary between the non-overlapped region NR and the overlapped region DR.

### 2-3: Modification 3

The projection apparatuses 10A to 10C explained above include the projectors 11 including the liquid crystal panels as the projectors 11. However, the projection apparatuses 10A to 10C may be projection apparatuses including digital micro-mirror devices (DMDs) instead of the liquid crystal panels.

### 3: Summary of the Present Disclosure

A summary of the present disclosure is appended below.
(Appendix 1) A correction value calculation method including: calculating, based on a target tone value, a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface; and calculating, based on the first color unevenness correction value, for the second portion, a brightness correction value for performing brightness correction for reducing a difference in brightness of black between the first portion and the second portion on the projection surface.

The correction value calculation method described in Appendix 1 includes calculating the first color unevenness correction value for correcting the color unevenness of the first image and thereafter calculating, based on the first color unevenness correction value, the brightness correction value for performing the brightness correction for reducing the difference in the brightness of black between the first portion and the second portion. Accordingly, since the brightness correction corresponding to the color unevenness correction value is performed, when there is color unevenness of black in the entire projection image, the color unevenness can be corrected.

When a plurality of projection apparatuses are disposed to perform tiling display, in order to correct color unevenness and brightness in the overlapped region DR, it is conceivable to use both of a color unevenness correction circuit that corrects color unevenness and a brightness correction circuit that corrects brightness. However, when the brightness of black is corrected first, since an image of black with a tone 0 cannot be displayed in the non-overlapped region NR, the color unevenness of black cannot be corrected. Conversely, when the color unevenness of black is corrected first, when the brightness is corrected because of characteristics of the liquid crystal panel, color unevenness different from the color unevenness at the time when the image of black with the tone 0 is displayed occurs and, even after the brightness is corrected, the color unevenness of black sometimes remains.

Since the correction value calculation method described in Appendix 1 has the configuration explained above, it is possible to highly accurately correct both the color unevenness and the brightness of black in the entire projection image.
(Appendix 2) The correction value calculation method described in Appendix 1, further including calculating, based on the brightness correction value, for each of a plurality of second correction points included in the second portion, a second color unevenness correction value for correcting the color unevenness of the first image.

Since the correction value calculation method described in Appendix 2 has the configuration explained above, it is possible to correct color unevenness in the non-overlapped region NR.
(Appendix 3) The correction value calculation method described in Appendix 2, wherein the calculating the brightness correction value includes: calculating a provisional brightness correction value for each of a plurality of third correction points adjacent to the first portion among the plurality of second correction points based on the first color unevenness correction value of the first correction point adjacent to each of the plurality of third correction points among the plurality of first correction points; and calculating the brightness correction value for the second portion by statistically processing the provisional brightness correction value for the plurality of third correction points.

Since the correction value calculation method described in Appendix 3 has the configuration explained above, it is possible to suppress rapid changes in brightness and chromaticity between both of the overlapped region DR and the non-overlapped region NR across the boundary between the overlapped region DR and the non-overlapped region NR.
(Appendix 4) The correction value calculation method described in Appendix 3, wherein the calculating the provisional brightness correction value is calculating, for each of the plurality of third correction points, the provisional brightness correction value in a case in which, for each of the plurality of third correction points, the second color unevenness correction value is made equal to the first color unevenness correction value of the first correction point adjacent to each of the plurality of third correction points. Since the correction value calculation method described in Appendix 4 has the configuration explained above, it is possible to finely correct the brightness in the projection image PI_A by calculating the provisional brightness correction value for each of the plurality of third correction points.
(Appendix 5) The correction value calculation method described in Appendix 3, wherein the calculating the second color unevenness correction value includes calculating, for each of the plurality of third correction points, the second color unevenness correction value based on the brightness correction value for the second portion.

Since the correction value calculation method described in Appendix 5 has the configuration explained above, it is possible to finely correct color unevenness in the projection image PI_A by calculating the second color unevenness correction value for each of the plurality of third correction points.
(Appendix 6) A non-transitory computer-readable storage medium storing a program, the program causing a computer to execute: calculating, based on a target tone value, a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface; and calculating, based on the first color unevenness correction value, for the second portion, a brightness correction value for performing brightness correction for reducing a difference in brightness of black between the first portion and the second portion on the projection surface.

The program stored in the non-transitory computer-readable storage medium described in Appendix 6 causes the computer to calculate the first color unevenness correction value for correcting the color unevenness of the first image and thereafter calculate the brightness correction value for performing the brightness correction for reducing the difference in the brightness of black between the first portion and the second portion based on the first color unevenness correction value. Accordingly, since the brightness correction corresponding to the color unevenness correction value is performed, when there is color unevenness of black in the entire projection image, the color unevenness can be corrected.

When a plurality of projection apparatuses are disposed to perform tiling display, in order to correct color unevenness and brightness in the overlapped region DR, it is conceivable to use both of a color unevenness correction circuit that corrects color unevenness and a brightness correction circuit that corrects brightness. However, when the brightness of black is corrected first, since an image of black with a tone 0 cannot be displayed in the non-overlapped region NR, the color unevenness of black cannot be corrected. Conversely, when the color unevenness of black is corrected first, when the brightness is corrected because of characteristics of the liquid crystal panel, color unevenness different from the color unevenness at the time when the image of black with the tone 0 is displayed occurs and, even after the brightness is corrected, the color unevenness of black sometimes remains.

Since the program stored in the non-transitory computer-readable storage medium described in Appendix 6 has the configuration explained above, it is possible to highly accurately correct both the color unevenness and the brightness of black in the entire projection image.
(Appendix 7) A projection apparatus including at least one image processing circuit configured to execute: calculating, based on a target tone value, a first color unevenness correction value for correcting color unevenness of a first image for each of a plurality of first correction points included in a first portion of the first image, the first image including the first portion projected onto a projection surface and overlapping, on the projection surface, a second image projected by another projection apparatus onto the projection surface and a second portion projected onto the projection surface and not overlapping the second image on the projection surface; and calculating, based on the first color unevenness correction value, for the second portion, a brightness correction value for performing brightness correction for reducing a difference in brightness of black between the first portion and the second portion on the projection surface.

The projection apparatus described in Appendix 7 calculates the first color unevenness correction value for correcting the color unevenness of the first image and thereafter calculate the brightness correction value for performing the brightness correction for reducing the difference in the brightness of black between the first portion and the second portion based on the first color unevenness correction value. Accordingly, since the brightness correction corresponding to the color unevenness correction value is performed, when there is color unevenness of black in the entire projection image, the color unevenness can be corrected.

When a plurality of projection apparatuses are disposed to perform tiling display, in order to correct color unevenness and brightness in the overlapped region DR, it is conceivable to use both of a color unevenness correction circuit that corrects color unevenness and a brightness correction circuit that corrects brightness. However, when the brightness of black is corrected first, since an image of black with a tone 0 cannot be displayed in the non-overlapped region NR, the color unevenness of black cannot be corrected. Conversely, when the color unevenness of black is corrected first, when the brightness is corrected because of characteristics of the liquid crystal panel, color unevenness different from the color unevenness at the time when the image of black with the tone 0 is displayed occurs and, even after the brightness is corrected, the color unevenness of black sometimes remains.

Since the projection apparatus described in Appendix 7 has the configuration explained above, it is possible to highly accurately correct both the color unevenness and the brightness of black in the entire projection image.

What is claimed is:

1. A correction value calculation method comprising:
calculating, based on a target tone value, a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface; and
calculating, based on the first color unevenness correction value, for the second portion, a brightness correction value for performing brightness correction for reducing a difference in brightness of black between the first portion and the second portion on the projection surface.

2. The correction value calculation method according to claim 1, further comprising calculating, based on the brightness correction value, for each of a plurality of second correction points included in the second portion, a second color unevenness correction value for correcting the color unevenness of the first image.

3. The correction value calculation method according to claim 2, wherein
the calculating the brightness correction value includes:
calculating a provisional brightness correction value for each of a plurality of third correction points adjacent to the first portion among the plurality of second correction points based on the first color unevenness correction value of the first correction point adjacent to each of the plurality of third correction points among the plurality of first correction points; and
calculating the brightness correction value for the second portion by statistically processing the provisional brightness correction value for the plurality of third correction points.

4. The correction value calculation method according to claim 3, wherein the calculating the provisional brightness correction value is calculating, for each of the plurality of third correction points, the provisional brightness correction value in a case in which, for each of the plurality of third correction points, the second color unevenness correction value is made equal to the first color unevenness correction value of the first correction point adjacent to each of the plurality of third correction points.

5. The correction value calculation method according to claim 3, wherein the calculating the second color unevenness correction value includes calculating, for each of the plurality of third correction points, the second color unevenness correction value based on the brightness correction value for the second portion.

6. A non-transitory computer-readable storage medium storing a program, the program causing a computer to execute:
calculating, based on a target tone value, a first color unevenness correction value for correcting color unevenness of a first image for each of a plurality of first correction points included in a first portion of the first image, the first image including the first portion projected from a first projection apparatus onto a projection surface and overlapping, on the projection surface, a second image projected by a second projection apparatus onto the projection surface and a second portion projected from the first projection apparatus onto the projection surface and not overlapping the second image on the projection surface; and
calculating, based on the first color unevenness correction value, for the second portion, a brightness correction value for performing brightness correction for reducing a difference in brightness of black between the first portion and the second portion on the projection surface.

7. A projection apparatus including at least one image processing circuit configured to execute:
calculating, based on a target tone value, a first color unevenness correction value for correcting color unevenness of a first image for each of a plurality of first correction points included in a first portion of the first image, the first image including the first portion projected onto a projection surface and overlapping, on the projection surface, a second image projected by another projection apparatus onto the projection surface and a second portion projected onto the projection surface and not overlapping the second image on the projection surface; and
calculating, based on the first color unevenness correction value, for the second portion, a brightness correction value for performing brightness correction for reducing a difference in brightness of black between the first portion and the second portion on the projection surface.
